(19) United States
(12) Patent Application Publication
(10) Pub. No.: US 2025/0390001 A1
(43) Pub. Date: Dec. 25, 2025

(54) NON-INTERFEROMETRIC THIN FILM LITHIUM NIOBATE MODULATOR FOR DATA TRANSMISSION

(71) Applicant: OPTILAB, LLC, Phoenix, AZ (US)

(72) Inventors: Henry H. Hung, Paradise Valley, AZ (US); Ke Huang, Phoenix, AZ (US); Leijun Yin, Tempe, AZ (US); Xiaoyan Ying, Tempe, AZ (US)

(21) Appl. No.: 18/749,225

(22) Filed: Jun. 20, 2024

(51) Int. Cl. G02F 1/313

(52) U.S. Cl. CPC G02F 1/3137; G02F 2202/20

(57) ABSTRACT

A non-interferometric thin film lithium niobate electro-optical modulator for data transmission including a laser, configured to generate an input continuous wave light beam; a non-interferometric thin film lithium niobate modulator including an optical waveguide situated along with the coplanar transmission lines and the DC bias conductors. The propagation constant of the optical waveguide is tuned and modulated by the RF data signal and the DC bias voltage traveling on the coplanar transmission lines and the DC bias conductors. The modulator can be tuned at quadrature point by the DC bias voltage. The optical power can be modulated by the RF data signal travelling on the coplanar transmission line; a low noise RF amplifier for data signal amplification; and a bias tee for combining the data signal and DC bias voltage and send them to the coplanar transmission lines.

### BACKGROUND

Aspects of the present disclosure relate generally to electro-optical modulators or other electro-optical devices for data transmission and in particular to a Non-Interferometric Thin Film Lithium Niobate TFLN electro-optical modulator or other electro-optical devices free of feedback bias control for data transmission

### BACKGROUND

An electro-optical modulator is used to modulate a continuous wave CW laser or optical signal with a radio frequency RF signal for data transmission to a remote device With regard to such application the electro-optical modulator should be biased to a quadrature point for high stability Additionally it is also generally desirable to apply simple and straight-ford bias control mechanism use less electronic components and reduce the power consumption and cost Further it is generally desirable to avoid the bias drift caused by external perturbations, e.g., temperature humidity, stress, aging, vibration, etc.

### SUMMARY

The following presents a simplified summary of one or more embodiments in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as prelude to the more detailed description that is presented later.

It is therefore a primary object of the present invention to provide a non-interferometric thin film lithium niobate electro-optical modulator for data transmission.

It is another object of the invention to provide a non-interferometric thin film lithium niobate electro-optical modulator with the planar electrode to control the bias point by tuning the propagation constant β of the optical waveguides.

It is a further object of invention to provide a non-interferometric thin film lithium niobate electro-optical modulator with travelling wave planar electrodes to achieve data transmission by modulating the propagation constant β of the optical waveguides.

An aspect of the present invention relates to an apparatus, comprising: an electro-optical modulator, comprising: an optical splitter including: an input port configured to receive a continuous wave (CW) laser power; a first output port; and a second output port; a first optical waveguide including a first input port coupled to the first output port of the optical splitter and a first output port; a second optical waveguide including a second input port coupled to the second output port of the optical splitter and a terminated port; a signal transmission line extending substantially parallel with and situated laterally between the first and second optical waveguides; a first grounded transmission line extending substantially parallel with the first optical waveguide, wherein the first optical waveguide is situated laterally between the signal transmission line and the first grounded transmission line; and a second grounded transmission line extending substantially parallel with the second optical waveguide, wherein the second optical waveguide is situated laterally between the signal transmission line and the second grounded transmission line.

Another aspect of the present invention relates to an apparatus, comprising: an electro-optical modulator, comprising: a first optical waveguide including an input port configured to receive a continuous wave (CW) laser and a first terminated port; a second optical waveguide including a second terminated port and an output port; a signal transmission line extending substantially parallel with and situated laterally between the first and second optical waveguides; a first grounded transmission line extending substantially parallel with the first optical waveguide, wherein the first optical waveguide is situated laterally between the signal transmission line and the first grounded transmission line; and a second grounded transmission line extending substantially parallel with the second optical waveguide, wherein the second optical waveguide is situated laterally between the signal transmission line and the second grounded transmission line.

Another aspect of the present invention relates to an apparatus, comprising: an electro-optical modulator, comprising: a Y-combiner including a first input port configured to receive a continuous wave (CW) laser, a first terminated port, and a first output port; a Y-splitter including a second input port, a second output port, and a second terminated port; an optical waveguide including an input port coupled to the first output port of the Y-combiner, and an output port coupled to the second input port of the Y-splitter; a signal transmission line extending substantially parallel with and overlying the optical waveguide; and first and second grounded transmission lines extending substantially parallel with and situated laterally on both sides of the signal transmission, respectively.

The aspect of the invention may be better understood by referring to the following description in conjunction with the accompanying drawings. Identical or similar elements in these figures may be designated by the same reference numerals. Detailed description about these similar elements may not be repeated. The drawings are not necessarily to scale. The skilled artisan will understand that the drawings, described below, are for illustration purposes only. The drawings are not intended to limit the scope of the present teachings in any way.

### BRIEF DESCRIPTION OF THE DRAWINGS

FIG.1 illustrates a block diagram of an example lithium niobate electro-optical modulator with feedback bias control for data transmission in accordance with an aspect of the disclosure.

FIG.2 illustrates a block diagram of an example lithium niobate electro-optical modulator with feedback bias control for data transmission in accordance with another aspect of the disclosure.

FIG.3 illustrates a drift of a lithium niobate electro-optical modulator transfer function as a result of bias drift of the modulator and the resulting distortion of the modulated optical signal.

FIG.4 illustrates a block diagram of an example non-interferometric thin film lithium niobate electro-optical modulator for data transmission in accordance with another aspect of the disclosure.

FIG.5 illustrates a block diagram of another example non-interferometric thin film lithium niobate electro-optical modulator for data transmission in accordance with another aspect of the disclosure.

FIG.6 illustrates a block diagram of another example non-interferometric thin film lithium niobate electro-optical modulator for data transmission in accordance with another aspect of the disclosure.

FIG. 7 illustrates a block diagram of another example non-interferometric thin film lithium niobate electro-optical modulator for data transmission in accordance with another aspect of the disclosure.

FIG. 8 illustrates a cross-sectional view of an example non-interferometric thin film lithium niobate electro-optical modulator of FIGS. 4-7 in accordance with another aspect of the disclosure.

FIG. 9 illustrates a block diagram of another example non-interferometric thin film lithium niobate electro-optical modulator for data transmission in accordance with another aspect of the disclosure.

FIG. 10 illustrates a block diagram of another example non-interferometric thin film lithium niobate electro-optical modulator for data transmission in accordance with another aspect of the disclosure.

FIG. 11 illustrates a cross-sectional view of an example non-interferometric thin film lithium niobate electro-optical modulator of FIGS. 9 and 10 in accordance with another aspect of the disclosure.

FIG. 12 illustrates a transfer function of an example non-interferometric thin film lithium niobate electro-optical modulator of FIGS. 4 and 5 and an application on Pulse Amplitude Modulation with four levels (PAM4) data transmission in accordance with another aspect of the disclosure.

FIG. 13 illustrates a transfer function of an example non-interferometric thin film lithium niobate electro-optical modulator of FIGs.6 and 7 and an application on Pulse Amplitude Modulation with four levels (PAM4) data transmission in accordance with another aspect of the disclosure.

FIG. 14 illustrates a transfer function of an example non-interferometric thin film lithium niobate electro-optical modulator of FIGs.9 and 10 and an application on Pulse Amplitude Modulation with four levels (PAM4) data transmission in accordance with another aspect of the disclosure.

FIG. 15 illustrates a graph of an example optical group refractive index (optical signal velocity) and RF wave refractive index (RF velocity) versus driving frequency of the non-interferometric electro-optical modulator of FIGS. 4 and 5 in accordance with another aspect of the disclosure.

FIG. 16 illustrates a graph of an example optical group refractive index (optical signal velocity) and RF wave refractive index (RF velocity) versus driving frequency of the non-interferometric electro-optical modulator of FIGS. 6 and 7 in accordance with another aspect of the disclosure.

FIG. 17 illustrates a graph of an example optical group refractive index (optical signal velocity) and RF wave refractive index (RF velocity) versus driving frequency of the non-interferometric electro-optical modulator of FIGS. 9 and 10 in accordance with another aspect of the disclosure.

FIG. 18 illustrates a graph of an example amplitude of the fundamental frequency, second, and third harmonics that are generated in the optical power when a sinusoidal input data signal with different modulation depth is applied to the transfer function of FIG. 12 in accordance with another aspect of the disclosure.

FIG. 19 illustrates a graph of an example amplitude of the fundamental frequency, second, and third harmonics that are generated in the optical power when a sinusoidal input data signal with different modulation depth is applied to the transfer function of FIG. 13 in accordance with another aspect of the disclosure.

FIG. 20 illustrates a graph of an example amplitude of the fundamental frequency, second, and third harmonics that are generated in the optical power when a sinusoidal input data signal with different modulation depth is applied to the transfer function of FIG. 14 in accordance with another aspect of the disclosure.

FIG. 21 illustrates a block diagram of another example non-interferometric thin film lithium niobate electro-optical modulators for multi-channel data transmission in accordance with another aspect of the disclosure.

### DETAILED DESCRIPTION

The detailed description set forth below, in connection with the appended drawings, is intended as a description of various configurations and is not intended to represent the only configurations in which the concepts described herein may be practices. The detailed description includes specific details for the purpose of providing a thorough understanding of the various concepts. However, it will be apparent to those skilled in the art that these concepts mat be practiced without these specific details. In some instances, well-known structures and components are shown in block diagram form in order to avoid obscuring such concepts. The term “substantially” with reference to a parameter accounts for tolerances for slight real practice variations associated with the parameter.

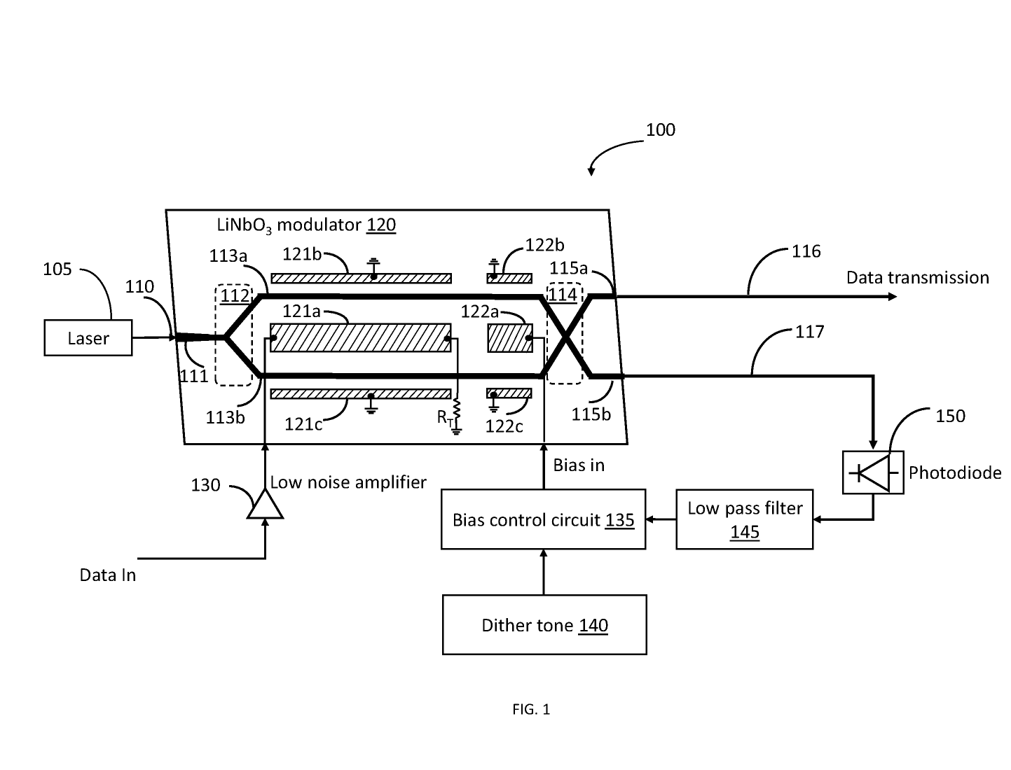

FIG. 1 illustrates a block diagram of an example interferometrical Mach Zehnder electro-optical modulator (MZM) 120 for data transmission 100 in accordance with another aspect of the disclosure. The example MZM 120 may be implemented as a Thin-film Lithium Niobate (LiNbO₃) (TFLN) Mach Zehnder interferometer (MZI) electro-optical modulator.

In the optical domain, the data transmission diagram 100 includes a CW laser 105, a single mode optical waveguide 110, an MZM 120, an output optical waveguide 116 (or output optical fiber 116), and an output optical waveguide 117 (or output optical fiber 117).

In the optical domain, the MZM 120 includes an input optical mode converter 111, an input optical Y-splitter 112, a first optical waveguide branch 113a, a second optical waveguide branch 113b, a 2×2 splitter 114, a first output single mode optical waveguide 115a, and a second output single mode optical waveguide 115b.

The CW optical power from the laser 105 is coupled to an input port of the input mode converter 111 through a single mode optical waveguide 110. The input mode converter 111 has its optical output power coupled to an input port of the Y-splitter 112. The first optical waveguide branch 113a is optically coupled between a first output port of the Y-splitter 112 and the first input port of the 2×2 splitter 114. The second optical waveguide branch 113b is optically coupled between a second output port of the Y-splitter 112 and the second input port of the 2×2 splitter 114. The 2×2 splitter 114 has its first output port optically coupled to a first output optical waveguide 115a. The 2×2 splitter 114 has its second output port optically coupled to a second output optical waveguide 115b. The output optical waveguide 115a has its output port optically coupled to an input port of an output optical waveguide 116 (or output optical fiber 116). The output optical waveguide 116 (or output optical fiber 116) has its output port coupled to a remote receiver (not shown). The output optical waveguide 115b has its output port optically coupled to an input port of an output optical waveguide 117 (or output optical fiber 117). The output optical waveguide 117 (or output optical fiber 117) has its output port coupled to a photodiode 150.

The output optical waveguide 117 can be an individual external optical fiber, or it can be an optical waveguide that is fabricated in the MZM 120.

In the electrical domain, the data transmission diagram 100 includes a MZM 120, a low noise RF amplifier (LNA) 130, a photodiode 150, a low pass RF filter 145 (LPF) (e.g., pass band may be between direct current (DC) (zero (0) Hertz (Hz) to five (5) kilo Hertz (kHz)), a bias control circuit 135 and a dither tone 140.

The MZM 120 includes a signal transmission line 121a of a coplanar stripline further including first and second grounded transmission lines 121b and 121c. The signal transmission line 121a includes a second end coupled to a termination resistor R_{T} (e.g., 50 Ohms) coupled to ground. The MZM 120 further includes a direct current (DC) bias voltage electrical conductor 122a and associated first and second grounded electrical conductors 122b and 122c. The DC bias voltage conductor 122a is configured to receive a DC bias voltage.

The LNA 130 includes an input configured to receive a radio frequency (RF) signal. The LNA 130 also includes an output coupled to a first end of a signal transmission line 121a in the MZM 120.

The signal transmission line 121a extends parallel with and is situated laterally between the first and second optical waveguide branches 113a and 113b. The first optical waveguide branch 113a extends parallel with and is laterally situated between the signal transmission line 121a and the first grounded transmission line 121b of the coplanar stripline. Similarly, the second optical waveguide branch 113b extends parallel with and is laterally situated between the signal transmission line 121a and the second grounded transmission line 121c of the coplanar stripline. The DC bias conductor 122a is also situated laterally between the first and second optical waveguide branches 113a and 113b. The first optical waveguide branch 113a is laterally situated between the DC bias conductor 122a and the first grounded bias conductor 122b. Similarly, the second optical waveguide branch 113b is laterally situated between the DC bias conductor 122a and the second grounded bias conductor 122c.

The photodiode 150 has its input port configured to receive the optical signal from the output port of an output optical waveguide 117, the photodiode 150 converts the optical signal into electrical signal and then sends the electrical signal out through its output port to the input port of the LPF 145. The LPF 145 includes an output port coupled to a first input port of a bias control circuit 135. The bias control circuit 135 has its output port coupled to the end of the DC bias conductor 122a.

The dither tone 140 generates low frequency (e.g., 1kHz) modulated electrical signal (e.g., sinusoidal wave) and sends the signal to the second input port of the bias control circuit 135.

The photodiode 150, the LPF 145, and the bias control circuit 135 can be individual external components or can be fabricated or integrated in the MZM 120.

In operation, the CW optical signal from the laser 105 is coupled to the two optical waveguides branches 113a and 113b of the MZM 120 through the single mode optical waveguide 110, mode converter 111 and Y-splitter 112. Data signal is amplified by the LNA 130 and then applied to transmission line electrode 121a for the modulation of the phase difference between the two optical signals travelling in optical waveguide branches 113a and 113b; by doing this the data can be encoded to the optical signal. The data encoding should be done when the MZM 120 is substantially stabilized at quadrature point. The modulated optical signal exits the MZM 120 after passing though the 2×2 splitter 114 and single mode optical waveguide 115a and 115b. A part of the optical signal is transferred to the remote receiver from the single mode optical waveguide 115a though the output optical waveguide 116 (or output optical fiber 116), the other part of the optical signal is transferred from the single mode optical waveguide 115b to the photodiode 150 to be converted into an electrical signal. The electrical signal passes through the LPF 145 and enters the bias control circuit 135. The bias circuit 135 uses the electrical signal and the dither signal from the dither tone 140 to generate a DC bias control voltage, which is applied to the DC bias conductor 122a for tuning the phase difference between the two optical signals travelling in optical waveguide branches 113a and 113b in order to stabilize the electro-optical modulator at substantially quadrature point.

The output waveguide 115b, output optical waveguide 117, photodiode 150, LNA 145, bias control circuit 135 and the dither tone 140 is part of the feedback bias control circuit.

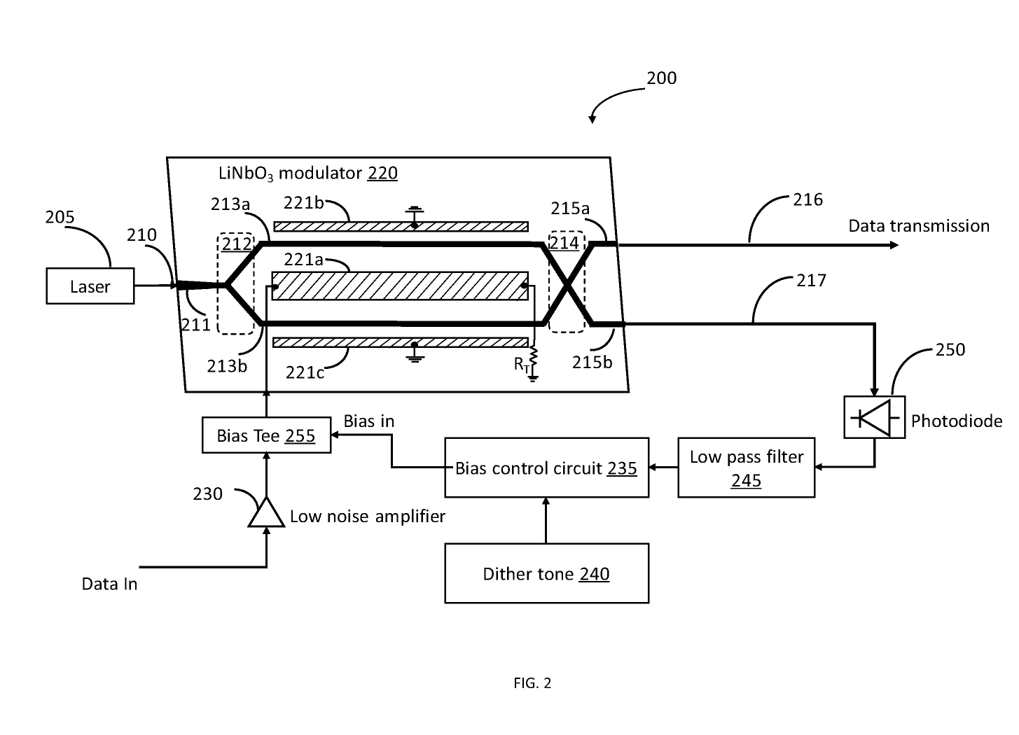

FIG. 2 illustrates a block diagram of an example interferometrical Mach Zehnder electro-optical modulator (MZM) 220 for data transmission 200 in accordance with another aspect of the disclosure. The example MZM 220 may be implemented as a Thin-film Lithium Niobate Mach Zehnder interferometer (MZI) electro-optical modulator.

In the optical domain, the data transmission diagram 200 includes a CW laser 205, a single mode optical waveguide 210, a MZM 220, an output optical waveguide 216 (or output optical fiber 216), and an output optical waveguide 217 (or output optical fiber 217).

In the optical domain, the MZM 220 includes an input optical mode converter 211, an input optical Y-splitter 212, a first optical waveguide branch 213a, a second optical waveguide branch 213b, a 2×2 splitter 214, a first output single mode optical waveguide 215a, and a second output single mode optical waveguide 215b.

The CW optical power from the laser 205 is coupled to an input port of the input mode converter 211 through a single mode optical waveguide 210. The input mode converter 211 has its optical output power coupled to an input port of the Y-splitter 212. The first optical waveguide branch 213a is optically coupled between a first output port of the Y-splitter 212 and the first input port of the 2×2 splitter 214. The second optical waveguide branch 213b is optically coupled between a second output port of the Y-splitter 212 and the second input port of the 2×2 splitter 214. The 2×2 splitter 214 has its first output port optically coupled to a first output optical waveguide 215a. The 2×2 splitter 214 has its second output port optically coupled to a second output optical waveguide 215b. The output optical waveguide 215a has its output port optically coupled to an input port of an output optical waveguide 216 (or output optical fiber 216). The output optical waveguide 216 (or output optical fiber 216) has its output port coupled to a remote receiver (not shown). The output optical waveguide 215b has its output port optically coupled to an input port of an output optical waveguide 217 (or output optical fiber 217). The output optical waveguide 217 (or output optical fiber 217) has its output port coupled to a photodiode 250.

The output optical waveguide 217 (or output optical fiber 217) can be an individual external optical fiber, or it can be an optical waveguide that is fabricated in the MZM 220.

In the electrical domain, the data transmission diagram 200 includes a MZM 220, a low noise RF amplifier (LNA) 230, a photodiode 250, a low pass RF filter 245 (LPF) (e.g., pass band may be between DC to 5 kHz), a bias control circuit 235, a dither tone 240, and a bias tee 255.

The MZM 220 includes a signal transmission line 221a of a coplanar stripline further including first and second grounded transmission lines 221b and 221c. The signal transmission line 221a includes a second end coupled to a termination resistor R_{T} (e.g., 50 Ohms) coupled to ground.

The LNA 230 includes an input configured to receive a radio frequency (RF) signal. The LNA 230 also includes an output coupled to a first input port of the bias tee 255 which has its output port coupled to the first end of the signal transmission line 221a.

The signal transmission line 221a extends parallel with and is situated laterally between the first and second optical waveguide branches 213a and 213b. The first optical waveguide branch 213a extends parallel with and is laterally situated between the signal transmission line 221a and the first grounded transmission line 221b of the coplanar stripline. Similarly, the second optical waveguide branch 213b extends parallel with and is laterally situated between the signal transmission line 221a and the second grounded transmission line 221c of the coplanar stripline.

The photodiode 250 has its input port configured to receive the optical signal from the output port of an output optical waveguide 217, the photodiode 250 converts the optical signal into an electrical signal and then sends the electrical signal through its output port to the input port of the LPF 245. The LPF 245 includes an output port coupled to a first input port of a bias control circuit 235. The bias control circuit 235 has its output port coupled to the second input port of the bias tee 255. The bias tee 255 has its output port coupled to the first end of the signal transmission line 221a.

The dither tone 240 generates low frequency (e.g., 1kHz) modulated electrical signal (e.g., sinusoidal wave) and sends the signal to the second input port of the bias control circuit 235.

The photodiode 250, the LPF 245, the bias control circuit 235, and the bias tee 255 can be individual external components or can be fabricated or integrated in the MZM 220.

In operation, the CW optical signal from the laser 205 is coupled to the two optical waveguides branches 213a and 213b of the MZM 220 through the single mode optical waveguide 210, mode converter 211 and Y-splitter 212. Data signal is amplified by the LNA 230 and then applied to transmission line electrode 221a through the bias tee 255 for the modulation of the phase difference between the two optical signals travelling in optical waveguide branches 213a and 213b; by doing this the data can be encoded to the optical signal. The data encoding should be done when the MZM 220 is substantially stabilized at quadrature point. The modulated optical signal exits the MZM 220 after passing though the 2×2 splitter 214. A part of the optical signal is transferred from optical waveguide 215a to the remote receiver though the output optical waveguide 216 (or output optical fiber 216), the other part of the optical signal is transferred from optical waveguide 215b to the photodiode 250 to be converted into an electrical signal. The electrical signal passes through the LPF 235 and enters the bias control circuit 235. The bias circuit 235 uses the electrical signal and the dither signal from the dither tone 240 to generate DC bias control voltage, which is applied to the bias tee 255. The bias tee 255 functions to combine the data signal from LNA 230 and the DC bias voltage from the bias control circuit 235 and then send the combined signal to the signal transmission line 221a to stabilize the MZM 220 at substantially quadrature point meanwhile modulating the optical signal.

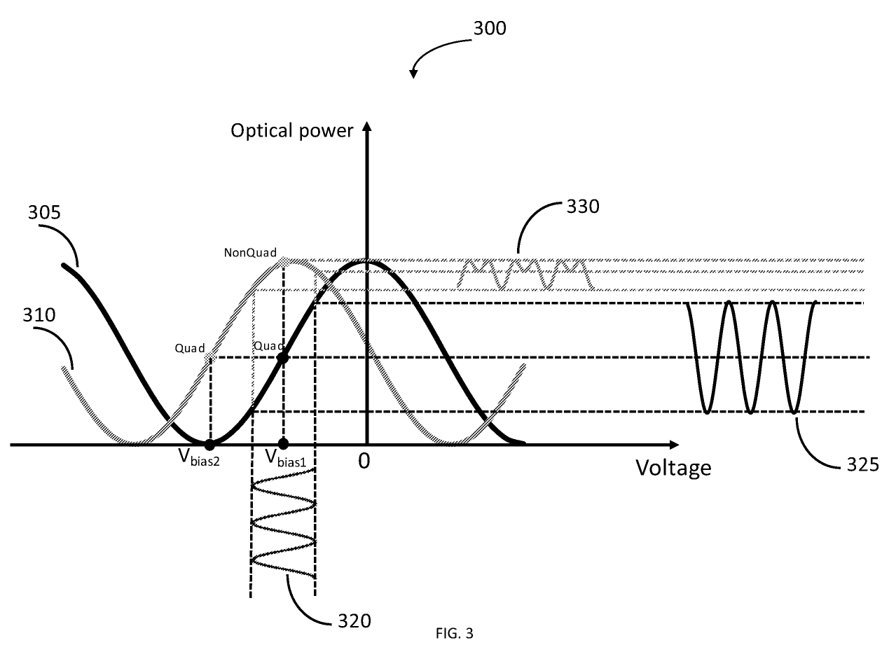

FIG. 3 illustrates a graph of an example transfer function of the MZM 120 or 220 for data transmission 100 or 200 in accordance with another aspect of the disclosure. The vertical axis shows the output optical power of the MZM 120 or 220, and the horizontal axis shows the voltage. Sinusoidal wave 305 is the transfer function of the MZM 120 or 220 when there is no bias drift and the sinusoidal function 310 is the transfer function of the MZM 120 or 220 when there is bias drift. RF signal 320 is the input data signal. Optical signals 330 and 325 are the optical output of the MZM when there is bias drift and no bias drift, respectively.

The V_{bias1} is the voltage applied to the MZM 120 or 220, when there is no bias drift (or the MZM has its transfer function 305), the V_{bias1} biases the MZM at substantially quadrature point (Quad point). The MZM provides the largest linear modulation range for data modulation, and so can maintain the best fidelity of the data transmission (or contains the least harmonics, e.g., 2^{nd} harmonics and so on in the modulated optical power).

The RF input data signal 320 modulates the transfer function 305 of the MZM 120 or 220 at Quad point. The modulation results in the output optical signal 325 which carries the data signal 320 with highest fidelity, the output optical signal 325 will be transferred to the remote receiver through output optical waveguide 116 or 216 (or output optical fiber 116 or 216).

However, MZM transfer function 305 may shift to the left or right due to external perturbations or aging of the MZM, here we take an example that the MZM transfer function 305 shifts to left which makes sinusoidal wave 310 the new transfer function of the MZM. The transfer function 310 has its Quad bias voltage of V_{bias2}. At this time the V_{bias1} biases the MZM at a non-quadrature point (NonQuad point). The fact that the MZM has its Quad point bias voltage shifts from V_{bias1} to V_{bias2} is called bias drift.

The RF input data signal 320 modulates the transfer function 310 of the MZM 120 or 220 at NonQuad point. The modulation results in the output optical signal 330 which carries the data signal 320 with poor fidelity (the optical signal 330 is distorted and contains many harmonics, e.g., 2^{nd} harmonics and so on).

In one embodiment, the MZM 120 or 220 needs the bias control signal from bias control circuit 135 or 235 to servo adjust the bias voltage from V_{bias1} to V_{bias2} in order to make MZM 120 or 220 working at Quad point.

The drawback of MZM 120 or 220 for data transmission 100 or 200 is that the bias voltage is tuning the phase difference between the two optical power that travelling in the optical waveguide branches 113a and 113b or 213a and 213b to make the MZM working at quadrature point, while the optical phase is also easily affected by external perturbations (e.g., temperature, vibration, stress and so on) and the aging of the MZM, so the bias voltage required for quadrature point operation keeps shifting in the real application. Feedback bias control circuit that includes optical waveguide 117 or 217, photodiode 150 or 250, LPF 145 or 245, dither tone 140 or 240 and bias control circuit 135 or 235 are mandatory to servo adjust the bias voltage that is applied to the electrode 122a or 221a to make the MZM stabilized at Quad point. The feedback bias control circuits make the system complex, costly and fragile, the failure of one component in the feedback bias control circuit will cause the failure of the system. Further in the multi-channel data transmission application, which is the trend of the modern broad band data com application, more than one MZM are operating in parallel in a single device, and each MZM needs its own feedback bias control circuits, the drawbacks are much more obvious.

Here we will introduce Non-Interferometric Thin Film Lithium Niobate Modulator (NI-TFLNM) for data transmission. Instead of tuning the phase difference in a MZM, the bias voltage tunes the propagation content β of the optical waveguide in NI-TFLNM to set it to work at quadrature point, the transfer function of the NI-TFLNM is much less affected by the external perturbations and the aging of the device, so the bias point is very stable, and no feedback bias control circuit required in the real application. Further, instead of modulating the phase difference in a MZM, the RF data signal modulates the propagation constant β of the NI-TFLNM to encode the data onto the optical power for transmission.

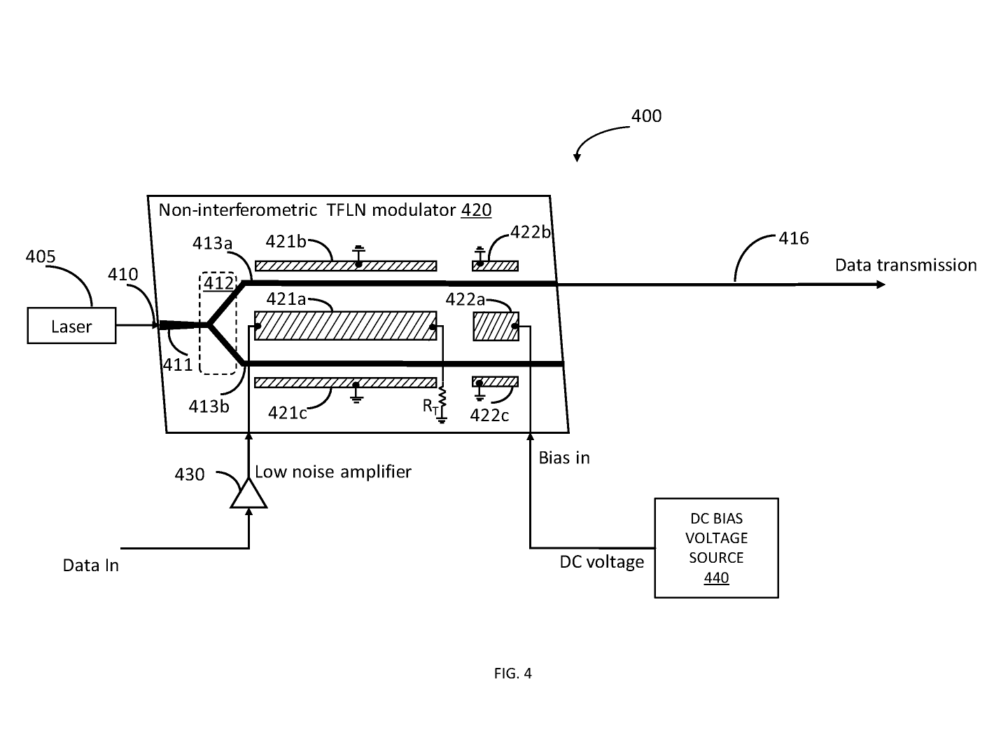

FIG. 4 illustrates a block diagram of an example NI-TFLNM 420 for data transmission 400 in accordance with another aspect of the disclosure. As described previously, the bias voltage tunes, and the data signal modulates the propagation constant β of the optical waveguide branches 413a and 413b of NI-TFLNM 420 to achieve the data transmission, the propagation constant β is not likely affected by external perturbations and the aging of the NI-TFLNM 420, so the bias is very stable, and no feedback bias control circuit required.

In the optical domain, the data transmission diagram 400 includes a CW laser 405, a single mode optical waveguide 410, a NI-TFLNM 420, and an output optical waveguide 416 (or output optical fiber 416).

In the optical domain, the NI-TFLNM 420 includes an input optical mode converter 411, an input optical Y-splitter 412, a first optical waveguide branch 413a, a second optical waveguide branch 413b.

The CW optical power from the laser 405 is coupled to an input port of the input mode converter 411 through a single mode optical waveguide 410. The input mode converter 411 has its optical output power coupled to an input port of the Y-splitter 412. The first optical waveguide branch 413a is optically coupled between a first output port of the Y-splitter 412 and the input port of the output optical waveguide 416 (or output optical fiber 416). The second optical waveguide branch 413b has its input port optically coupled to a second output port of the Y-splitter 412. The second optical waveguide branch 413b has its output port terminated on the right edge of the NI-TFLNM 420.

In the electrical domain, the data transmission diagram 400 includes a NI-TFLNM 420, a low noise RF amplifier (LNA) 430.

The NI-TFLNM 420 includes a signal transmission line 421a of a coplanar stripline further including first and second grounded transmission lines 421b and 421c. The signal transmission line 421a includes a second end coupled to a termination resistor R_{T} (e.g., 50 Ohms) coupled to ground. The NI-TFLNM 420 further includes a direct current (DC) bias voltage electrical conductor 422a and associated first and second grounded electrical conductors 422b and 422c. The DC bias voltage conductor 422a is configured to receive a DC bias voltage.

The LNA 430 includes an input configured to receive an electrical data signal. The LNA 430 also includes an output coupled to a first end of the signal transmission line 421a.

The signal transmission line 421a extends parallel with and is situated laterally between the first and second optical waveguide branches 413a and 413b. The first optical waveguide branch 413a extends parallel with and is laterally situated between the signal transmission line 421a and the first grounded transmission line 421b of the coplanar stripline. Similarly, the second optical waveguide branch 413b extends parallel with and is laterally situated between the signal transmission line 421a and the second grounded transmission line 421c of the coplanar stripline. The DC bias conductor 422a is also situated laterally between the first and second optical waveguide branches 413a and 413b. The first optical waveguide branch 413a is laterally situated between the DC bias conductor 422a and the first grounded conductor 422b. Similarly, the second optical waveguide branch 413b is laterally situated between the DC bias conductor 422a and the second grounded conductor 422c.

In operation, the CW optical signal from the laser 405 is coupled to the two optical waveguides branches 413a and 413b of the NI-TFLNM 420 through the single mode optical waveguide 410, mode converter 411 and Y-splitter 412. A DC bias voltage source 440 is configured to generate a substantially fixed or constant DC bias voltage applied to the DC bias conductor 422a to tune the propagation constant of the optical waveguide branches 413a and 413b to achieve a designated optical power coupling between the optical waveguide branches 413a and 413b, by doing this the NI-TFLNM 420 can be set to work at quadrature point. The value of the DC voltage is determined by the structure size (e.g., the distance between optical waveguide 413a and 413b, length of the DC bias conductor 422a and the associated grounded conductor 422b and 422c) of the NI-TFLNM 420. Data signal is amplified by the LNA 430 and then applied to transmission line electrode 421a for the modulation of the propagation constant of the optical waveguide branches 413a and 413b, the propagation constant modulation can induce the optical power coupling modulation between the optical waveguide branches 413a and 413b, by doing this the data can be encoded to the optical signal that travelling in either of the optical waveguide branches 413a and 413b. The data encoding must be done when the NI-TFLNM 420 is substantially stabilized at quadrature point, which, as prescribed, can be achieved by the fixed DC voltage. The modulated optical signal exits the NI-TFLNM 420 and transfers to the remote receiver through the output optical waveguide 416 (or output optical fiber 416).

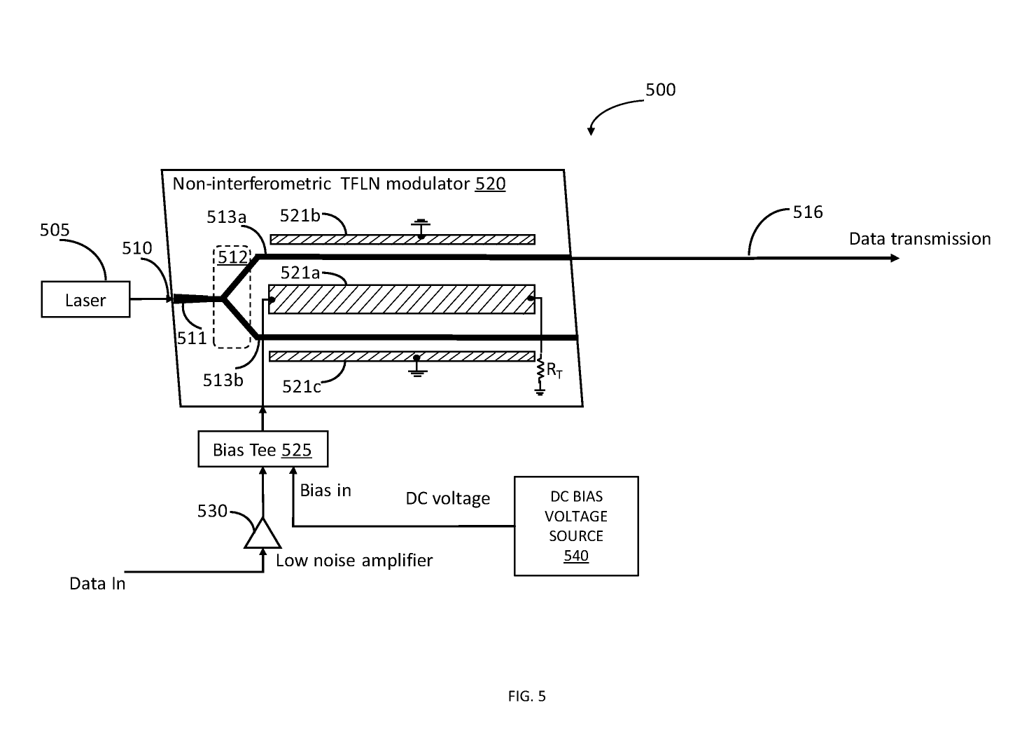

FIG. 5 illustrates a block diagram of another example NI-TFLNM 520 for data transmission 500 in accordance with another aspect of the disclosure. Similarly, the bias voltage tunes, and the data signal modulates the propagation constant of the optical waveguide branches 513a and 513b of NI-TFLNM 520 to achieve the data transmission, the propagation constant is not likely affected by external perturbations and the aging of the NI-TFLNM 520, so the bias is very stable, and no feedback bias control circuit required.

In the optical domain, the data transmission diagram 500 includes a CW laser 505, a single mode optical waveguide 510, a NI-TFLNM 520, and an output optical waveguide 516 (or output optical fiber 516).

In the optical domain, the NI-TFLNM 520 includes an input optical mode converter 511, an input optical Y-splitter 512, a first optical waveguide branch 513a, a second optical waveguide branch 513b.

The CW optical power from the laser 505 is coupled to an input port of the input mode converter 511 through a single mode optical waveguide 510. The input mode converter 511 has its optical output power coupled to an input port of the Y-splitter 512. The first optical waveguide branch 513a is optically coupled between the first output port of the Y-splitter 512 and the input port of the output optical waveguide 516 (or output optical fiber 516). The second optical waveguide branch 513b has its input port optically coupled to a second output port of the Y-splitter 512. The second optical waveguide branch 513b has its output port terminated on the right edge of the NI-TFLNM 520.

In the electrical domain, the data transmission diagram 500 includes a NI-TFLNM 520, a low noise RF amplifier (LNA) 530, and a bias tee 525.

The NI-TFLNM 520 includes a signal transmission line 521a of a coplanar stripline further including first and second grounded transmission lines 521b and 521c. The signal transmission line 521a includes a second end coupled to a termination resistor R_{T} (e.g., 50 Ohms) coupled to ground.

The LNA 530 includes an input configured to receive an electrical data signal. The LNA 530 also includes an output coupled to a first input port of a bias tee 525. The bias tee 525 has its second input configured to receive a DC bias voltage and has its output port coupled to the first end of the signal transmission line 521a.

The signal transmission line 521a extends parallel with and is situated laterally between the first and second optical waveguide branches 513a and 513b. The first optical waveguide branch 513a extends parallel with and is laterally situated between the signal transmission line 521a and the first grounded transmission line 521b of the coplanar stripline. Similarly, the second optical waveguide branch 513b extends parallel with and is laterally situated between the signal transmission line 521a and the second grounded transmission line 521c of the coplanar stripline.

In operation, the CW optical signal from the laser 505 is coupled to the two optical waveguides branches 513a and 513b of the NI-TFLNM 520 through the single mode optical waveguide 510, mode converter 511 and Y-splitter 512. The data signal is applied to the input port of the LNA 530 for amplification. The bias tee 525 receives amplified data signal from the output port of LNA 530 through its first input port. Further the bias tee receives a substantially fixed or constant DC bias voltage generated by a DC bias voltage source 540 through its second input port. The bias tee 525 combines the data signal and the DC voltage and sends them to the first end of the signal transmission line 521a through its output port. Specifically, the DC voltage will tune the propagation constant of the optical waveguide branches 513a and 513b to achieve a designated optical power coupling between the optical waveguide branches 513a and 513b, by doing this the NI-TFLNM 520 can be set to work at substantially quadrature point. The value of the DC voltage is determined by the structure size (e.g., the distance between optical waveguide 513a and 513b, length of the signal transmission line 521a and the associated grounded transmission lines 521b and 521c) of the NI-TFLNM 520. Data signal will modulate the propagation constant of the optical waveguide branches 513a and 513b, the propagation constant modulation can induce the optical power coupling modulation between the optical waveguide branches 513a and 513b, by doing this the data can be encoded to the optical signal that travelling in either of the optical waveguide branches 513a and 513b. The data encoding should be done when the NI-TFLNM 520 is substantially stabilized at quadrature point, which, as prescribed, can be achieved by the fixed DC voltage. The modulated optical signal exits the NI-TFLNM 520 and transfers to the remote receiver through the output optical waveguide 516 (or output optical fiber 516).

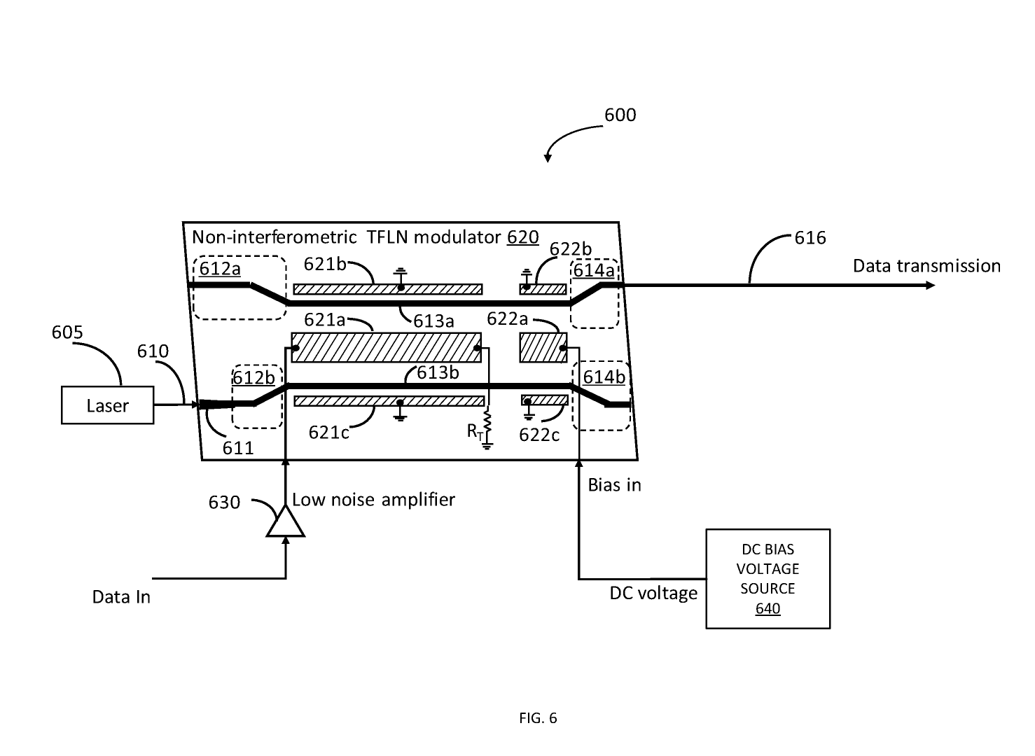

FIG. 6 illustrates a block diagram of another example NI-TFLNM 620 for data transmission 600 in accordance with another aspect of the disclosure. Similarly, the bias voltage tunes, and the data signal modulates the propagation constant of the optical waveguide branches 613a and 613b of NI-TFLNM 620 to achieve the data transmission, the propagation constant is not likely affected by external perturbations and the aging of the NI-TFLNM 620, so the bias is very stable, and no feedback bias control circuit required.

In the optical domain, the data transmission diagram 600 includes a CW laser 605, a single mode optical waveguide 610, a NI-TFLNM 620, and an output optical waveguide 616 (or output optical fiber 616).

In the optical domain, the NI-TFLNM 620 includes an input optical mode converter 611, a first input optical bend waveguide 612a and a second input optical bend waveguide 612b, a first optical waveguide branch 613a, a second optical waveguide branch 613b, a first output optical bend waveguide 614a, and a second output optical bend waveguide 614b.

The CW optical power from the laser 605 is coupled to an input port of the input mode converter 611 through a single mode optical waveguide 610. The input mode converter 611 has its optical output power coupled to an input port of the second input optical bend waveguide 612b. The second optical waveguide branch 613b is optically coupled between an output port of the second input optical bend waveguide 612b and the input port of the second output optical bend waveguide 614b. The output port of the second output bend waveguide 614b is terminated on the right edge of the IN-TFLNM 620. The input port of the first input optical bend waveguide 612a is terminated on the left edge of the IN-TFLNM 620. The first optical waveguide branch 613a is optically coupled between the output port of the first input optical bend waveguide 612a and the input port of the first output bend waveguide 614a. The first output bend waveguide 614a has its output port coupled to an input port of the output optical waveguide 616 (or output optical fiber 616).

In the electrical domain, the data transmission diagram 600 includes a NI-TFLNM 620, and a low noise RF amplifier (LNA) 630.

The NI-TFLNM 620 includes a signal transmission line 621a of a coplanar stripline further including first and second grounded transmission lines 621b and 621c. The signal transmission line 621a includes a second end coupled to a termination resistor R_{T} (e.g., 50Ohms) coupled to ground. The NI-TFLNM 620 further includes a direct current (DC) bias voltage electrical conductor 622a and associated first and second grounded electrical conductors 622b and 622c. The DC bias voltage conductor 622a is configured to receive a substantially fixed or constant DC bias voltage generated by a DC bias voltage source 640.

The LNA 630 includes an input configured to receive an electrical data signal. The LNA 630 also includes an output coupled to a first end of the signal transmission line 621a.

The signal transmission line 621a extends parallel with and is situated laterally between the first and second optical waveguide branches 613a and 613b. The first optical waveguide branch 613a extends parallel with and is laterally situated between the signal transmission line 621a and the first grounded transmission line 621b of the coplanar stripline. Similarly, the second optical waveguide branch 613b extends parallel with and is laterally situated between the signal transmission line 621a and the second grounded transmission line 621c of the coplanar stripline. The DC bias conductor 622a is also situated laterally between the first and second optical waveguide branches 613a and 613b. The first optical waveguide branch 613a is laterally situated between the DC bias conductor 622a and the first grounded conductor 622b. Similarly, the second optical waveguide branch 613b is laterally situated between the DC bias conductor 622a and the second grounded conductor 622c.

In operation, the CW optical signal from the laser 605 is coupled to the second optical waveguide branch 613b of the NI-TFLNM 620 through the single mode optical waveguide 410, mode converter 611 and the second input optical bend waveguide 612b. A fixed DC voltage is applied to the DC bias conductor 622a to tune the propagation constant of the optical waveguide branches 613a and 613b to achieve a designated optical power coupling between the optical waveguide branches 613a and 613b, by doing this the NI-TFLNM 620 can be set to work at quadrature point. The value of the DC voltage is determined by the structure size (e.g., the distance between optical waveguide 613a and 613b, length of the DC bias conductor 622a and the associated grounded conductor 622b and 622c) of the NI-TFLNM 620. Data signal is amplified by the LNA 630 and then applied to a first end of the transmission line electrode 621a for the modulation of the propagation constant of the optical waveguide branches 613a and 613b, the propagation constant modulation can induce the optical power coupling modulation between the optical waveguide branches 613a and 613b, by doing this the data can be encoded to the optical signal that travelling in either of the optical waveguide branches 613a and 613b. The data encoding should be done when the NI-TFLNM 620 is stabilized at quadrature point, which, as prescribed, can be achieved by the fixed DC voltage. The modulated optical signal exits the NI-TFLNM 620 and transfers to receiver through the output optical waveguide 616 (or output optical fiber 616).

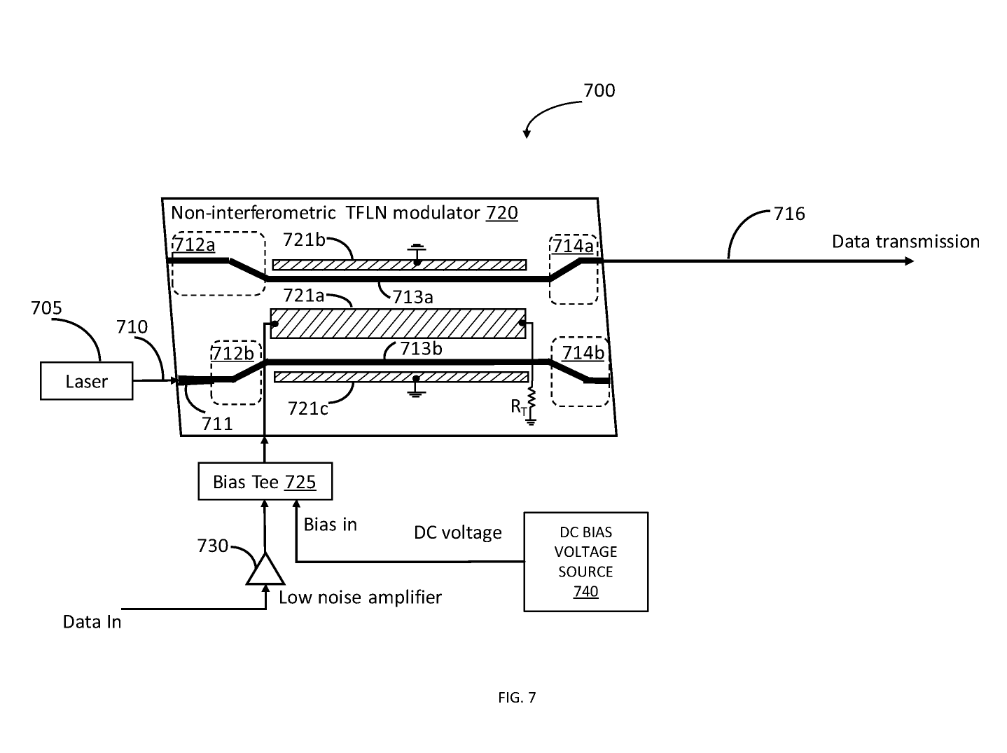

FIG.7 illustrates a block diagram of another example NI-TFLNM 720 for data transmission 700 in accordance with another aspect of the disclosure. Similarly, the bias voltage tunes, and the data signal modulates the propagation constant of the optical waveguide branches 713a and 713b of NI-TFLNM 720 to achieve the data transmission, the propagation constant is not likely affected by external perturbations and the aging of the NI-TFLNM 720, so the bias is very stable, and no feedback bias control circuit required.

In the optical domain, the data transmission diagram 700 includes a CW laser 705, a single mode optical waveguide 710, a NI-TFLNM 720, and an output optical waveguide 716 (or output optical fiber 716).

In the optical domain, the NI-TFLNM 720 includes an input optical mode converter 711, a first input optical bend waveguide 712a and a second input optical bend waveguide 712b, a first optical waveguide branch 713a, a second optical waveguide branch 713b, a first output optical bend waveguide 714a and a second output optical bend waveguide 714b.

The CW optical power from the laser 705 is coupled to an input port of the input optical mode converter 711 through a single mode optical waveguide 710. The input mode converter 711 has its optical output power coupled to an input port of the second input optical bend waveguide 712b. The second optical waveguide branch 713b is optically coupled between an output port of the second input optical bend waveguide 712b and the input port of the second output optical bend waveguide 714b. The output port of the second output bend waveguide 714b is terminated on the right edge of the IN-TFLNM 720. The input port of the first input optical bend waveguide 712a is terminated on the left edge of the IN-TFLNM 720. The first optical waveguide branch 713a is optically coupled between the output port of the first input optical bend waveguide 712a and the input port of the first output optical bend waveguide 714a. The first output optical bend waveguide 714a has its output port coupled to an input port of the output optical waveguide 716 (or output optical fiber 716).

In the electrical domain, the data transmission diagram 700 includes a NI-TFLNM 720, a low noise RF amplifier (LNA) 730, and a bias tee 725.

The NI-TFLNM 720 includes a signal transmission line 721a of a coplanar stripline further including first and second grounded transmission lines 721b and 721c. The signal transmission line 721a includes a second end coupled to a termination resistor R_{T} (e.g., 50 Ohms) coupled to ground.

The LNA 730 includes an input configured to receive an electrical data signal. The LNA 730 also includes an output coupled to a first input port of a bias tee 725. The bias tee 725 has its second input to receive a DC bias voltage and has its output port coupled to the first end of the signal transmission line 721a.

The signal transmission line 721a extends parallel with and is situated laterally between the first and second optical waveguide branches 713a and 713b. The first optical waveguide branch 713a extends parallel with and is laterally situated between the signal transmission line 721a and the first grounded transmission line 721b of the coplanar stripline. Similarly, the second optical waveguide branch 713b extends parallel with and is laterally situated between the signal transmission line 721a and the second grounded transmission line 721c of the coplanar stripline.

In operation, the CW optical signal from the laser 705 is coupled to the second optical waveguide branch 713b of the NI-TFLNM 720 through the single mode optical waveguide 710, mode converter 711 and the second input optical bend waveguide 712b. The data signal is applied to the input port of the LNA 730 for amplification. The bias tee 725 receives amplified data signal from the output port of LNA 730 through its first input port. Further the bias tee receives a substantially fixed or constant DC bias voltage generated by a DC bias voltage source 740 through its second input port. The bias tee 725 combines the data signal and the DC voltage and sends them to the first end of the signal transmission line 721a through its output port. Specifically, the DC voltage will tune the propagation constant of the optical waveguide branches 713a and 713b to achieve a designated optical power coupling between the optical waveguide branches 713a and 713b, by doing this the NI-TFLNM 720 can be set to work at quadrature point. The value of the DC voltage is determined by the structure size (e.g., the distance between optical waveguide 713a and 713b, length of the signal transmission line 721a and the associated grounded transmission lines 721b and 721c) of the NI-TFLNM 720. Data signal will modulate the propagation constant of the optical waveguide branches 713a and 713b, the propagation constant modulation can induce the optical power coupling modulation between the optical waveguide branches 713a and 713b, by doing this the data can be encoded to the optical signal that travelling in either of the optical waveguide branches 713a and 713b. The data encoding should be done when the NI-TFLNM 720 is stabilized at quadrature point, which, as prescribed, can be achieved by the fixed DC voltage. The modulated optical signal exits the NI-TFLNM 720 and transfers to receiver through output optical waveguide 716 (or output optical fiber 716).

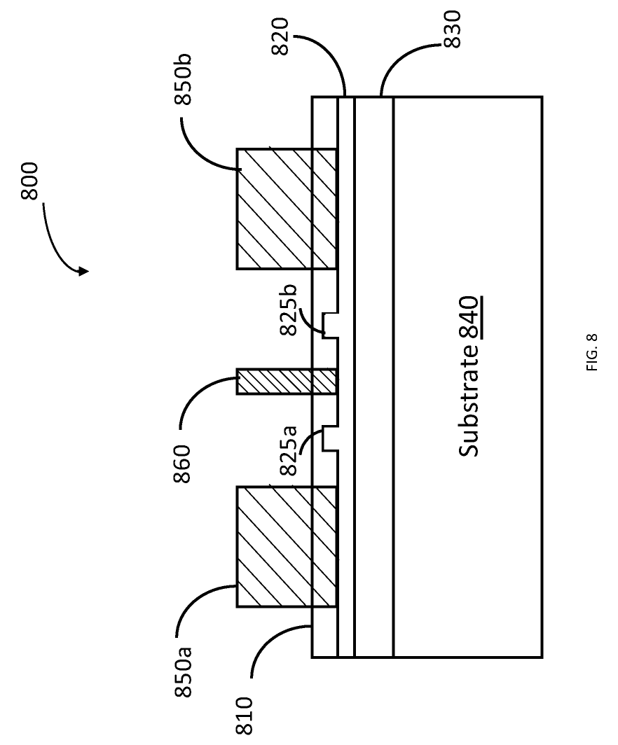

FIG. 8 illustrates a cross-sectional view of the example Non-interferometric Thin Film Lithium Niobate Modulator (NI-TFLNM) 420 (or 520, or 620, or 720) of FIGS. 4-7 along an axis transverse of the optical signal propagation in the modulation region (e.g., the region proximate the first and second optical signal branches) in accordance with another aspect of the disclosure, as shown, the NI-TFLNM 420 (or 520, or 620, or 720) may be formed on a substrate 840 (e.g., quartz, fused silica SiO₂, or silicon (Si) substrate). The NI-TFLNM 420 (or 520, 620, 720) further includes a bonding layer 830 (e.g., fused silica SiO₂, Silicon Oxynitride SiNₓO_{y}, epoxy, or glue) disposed over and/or on the substrate 840.

The NI-TFLNM 420 (or 520, or 620, or 720) includes a lithium niobate (LN) slab 820 including ridge waveguides 825a and 825b formed on top surface of the LN slab. The LN slab 820 is disposed over and/or on the bonding layer 830. That is, the bonding layer 830 serves to bond the LN slab 820 to the substrate 840. The ridge waveguides may be formed by Argon Ar⁺-based reactive ion etching of the LN slab 820. The NI-TFLNM 420 (or 520, or 620, or 720) further includes a buffer layer 810 (e.g., fused silica SiO₂, Silicon Oxynitride SiNₓO_{y}, epoxy, or glue) disposed over and/or on the LN slab 820 and ridge waveguides 825a and 825b.

The thickness of the substrate 840 may be around 0.5 mm or around 1 mm. The thickness of the bonding laser 830 may be between 0.5 (micrometer) μm and 10 μm. The thickness of the LN slab 820 may be between 100 nanometers (nm) and 500 nm. The thickness of the ridge waveguides 825a and 825b may be between 100 nm and 500 nm. The width of the ridge waveguides 825a and 825b may be between 400 nm and 1 μm. The thickness of the buffer layer 810 may be between 100 nm and 5 μm.

The NI-TFLNM 420 (or 520, or 620, or 720) further includes signal transmission line 860 and associated first and second grounded transmission line 850a and 850b of the coplanar stripline disposed over and/or on the LN slab 820. The coplanar stripline may be formed of any suitable electrical conductor, such as gold (Au) and may be embedded in the buffer layer 810.

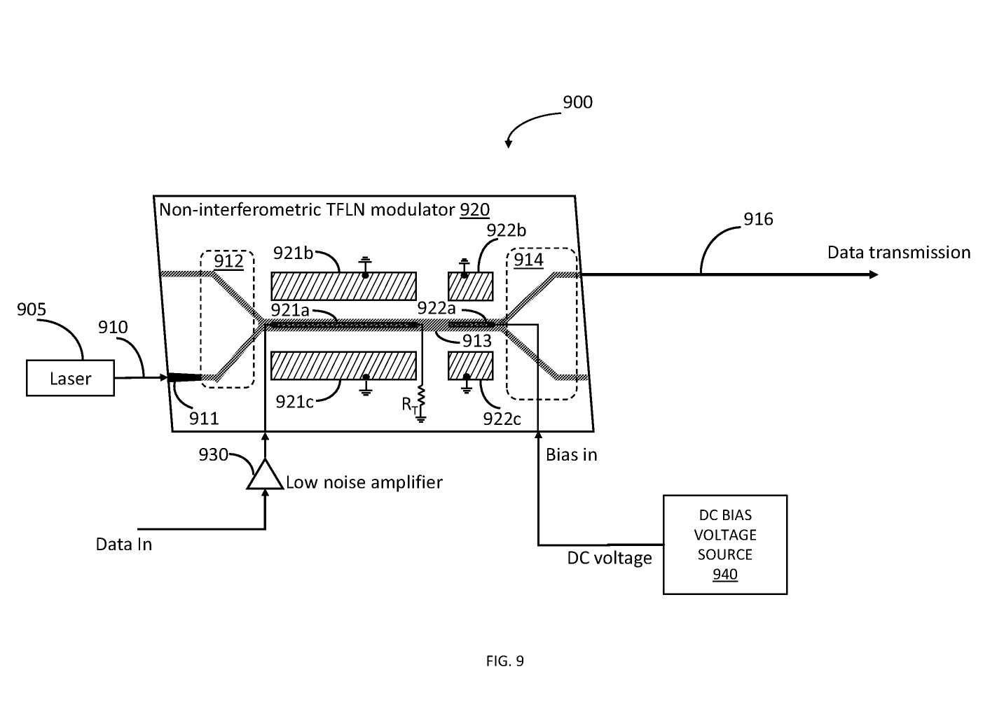

FIG. 9 illustrates a block diagram of another example NI-TFLNM 920 for data transmission 900 in accordance with another aspect of the disclosure. Similarly, the bias voltage tunes, and the data signal modulates the propagation constant of the optical travelling wave multimode waveguide (MMW) 913 of NI-TFLNM 920 to achieve the data transmission, the propagation constant is not likely affected by external perturbations and the aging of the NI-TFLNM 920, so the bias is very stable, and no feedback bias control circuit required.

In the optical domain, the data transmission diagram 900 includes a CW laser 905, a single mode optical waveguide 910, a NI-TFLNM 920, and an output optical waveguide 916 (or output optical fiber 916).

In the optical domain, the NI-TFLNM 920 includes an input optical mode converter 911, a Y-combiner 912, a MMW 913, and a Y-splitter 914.

The MMW 913 supports more than one optical mode to travel in it. The width of the MMW 913 may be between 5 μm and 20 μm.

The CW optical power from the laser 905 is coupled to an input port of the input mode converter 911 through a single mode optical waveguide 910. The input mode converter 911 has its optical output power coupled to a second input port of the Y-combiner 912 which has its first input port terminated on the left edge of the NI-TFLNM 920. The MMW 913 is optically coupled between the output port of the Y-combiner 912 and the input port of the Y-splitter 914. The Y-splitter 914 has its first output port coupled to the input port of the output optical waveguide 916 (or output optical fiber 916) and second output port terminated on the right edge of the NI-TFLNM 920.

In the electrical domain, the data transmission diagram 900 includes a NI-TFLNM 920, and a low noise RF amplifier (LNA) 930.

The NI-TFLNM 920 includes a signal transmission line 921a of a coplanar stripline further including first and second grounded transmission lines 921b and 921c. The signal transmission line 921a includes a second end coupled to a termination resistor R_{T} (e.g., 50 Ohms) coupled to ground. The NI-TFLNM 920 further includes a direct current (DC) bias voltage electrical conductor 922a and associated first and second grounded electrical conductors 922b and 922c. The DC bias voltage conductor 922a is configured to receive a substantially fixed or constant DC bias voltage generated by a DC bias voltage source 940.

The signal transmission line 921a has a width smaller than the width of the MMW 913.

The LNA 930 includes an input configured to receive an electrical data signal. The LNA 930 also includes an output coupled to a first end of the signal transmission line 921a.

The signal transmission line 921a extends along with the MMW 913 and in the middle of the MMW 913 viewed in the vertical direction of the drawing. The MMW 913 extends parallel with and is laterally situated between the first grounded transmission line 921b and 921c of the coplanar stripline. The DC bias conductor 922a also extends along with the MMW 913 and in the middle of the MMW 913 viewed in the vertical direction of the drawing. Similarly, the MMW 913 extends parallel with and is laterally situated between the first grounded conductor 922b and the second grounded conductor 922c.

In operation, the CW optical signal from the laser 905 is coupled to the MMW 913 through the single mode optical waveguide 910, mode converter 911 and the second input port of the Y-combiner 912 of the NI-TFLNM 920. A fixed DC voltage is applied to the DC bias conductor 922a to tune the propagation constant of the two halves of the MMW 913 (e.g., the half of MMW 913 closer to the first grounded transmission line 921b and conductor 922b, and the other half of MMW 913 closer to the second grounded transmission line 921c and conductor 922c), by doing this the optical power in MMW 913 can be selectively fed to the two output ports of the Y-splitter 914. With the designated optical power feeding, the NI-TFLNM 920 can be set to work at quadrature point. The value of the DC voltage is determined by the structure size (e.g., the widths of MMW 913 and DC bias conductor 922a, the length of the DC bias conductor 922a and the associated grounded conductors 922b and 922c) of the NI-TFLNM 620. Data signal is amplified by the LNA 930 and then applied to a first end of the transmission line electrode 921a for the modulation of the propagation constant of the two halves of the MMW 913, by doing this the optical power in MMW 913 can be modulated to the two output ports of the Y-splitter 914, and so the data can be encoded to the optical power that travels in either of the two output ports of the Y-splitter 914. The data encoding should be done when the NI-TFLNM 920 is stabilized at quadrature point, which, as prescribed, can be achieved by the fixed DC voltage. The modulated optical signal exits the NI-TFLNM 920 and transfers to the remote receiver through the output optical waveguide 916 (or output optical fiber 916).

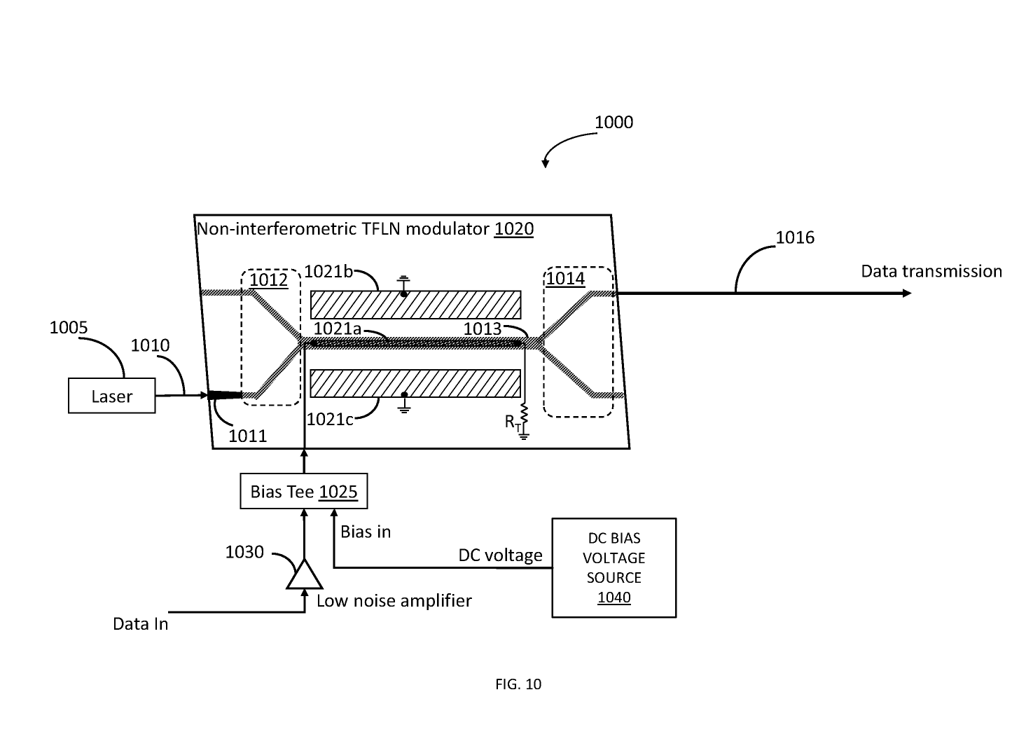

FIG. 10 illustrates a block diagram of another example NI-TFLNM 1020 for data transmission 1000 in accordance with another aspect of the disclosure. Similarly, the bias voltage tunes, and the data signal modulates the propagation constant of the optical travelling wave multimode waveguide (MMW) 1013 of NI-TFLNM 1020 to achieve the data transmission. The propagation constant is not likely affected by external perturbations and the aging of the NI-TFLNM 1020, so the bias is very stable, and no feedback bias control circuit required.

In the optical domain, the data transmission diagram 1000 includes a CW laser 1005, a single mode optical waveguide 1010, a NI-TFLNM 1020, and an output optical waveguide 1016 (or output optical fiber 1016).

In the optical domain, the NI-TFLNM 1020 includes an input optical mode converter 1011, a Y-combiner 1012, a MMW 1013, and a Y-splitter 1014.

The MMW 1013 supports more than one optical mode to travel in it. The width of the MMW 1013 is between 5 μm and 20 μm.

The CW optical power from the laser 1005 is coupled to an input port of the input mode converter 1011 through a single mode optical waveguide 1010. The input mode converter 1011 has its optical output power coupled to a second input port of the Y-combiner 1012 which has its first input port terminated on the left edge of the NI-TFLNM 1020. The MMW 1013 is optically coupled between the output port of the Y-combiner 1012 and the input port of the Y-splitter 1014. The Y-splitter 1014 has its first output port coupled to the input port of the output optical waveguide 1016 (or output optical fiber 1016) and second output port terminated at the right edge of the NI-TFLNM 1020.

In the electrical domain, the data transmission diagram 1000 includes a NI-TFLNM 1020, a low noise RF amplifier (LNA) 1030 and a bias tee 1025.

The NI-TFLNM 1020 includes a signal transmission line 1021a of a coplanar stripline further including first and second grounded transmission lines 1021b and 1021c. The signal transmission line 1021a includes a second end coupled to a termination resistor R_{T} (e.g., 50 Ohms) coupled to ground.

The signal transmission line 1021a has a width smaller than the width of the MMW1013.

The LNA 1030 includes an input configured to receive an electrical data signal. The LNA 1030 also includes an output coupled to a first input port of a bias tee 1025. The bias tee 1025 has its second input to receive a substantially constant or fixed DC bias voltage generated by a DC bias voltage source 1040 and has its output port coupled to the first end of the signal transmission line 1021a.

The signal transmission line 1021a extends along with the MMW 1013 and in the middle of the MMW 1013 viewed in the vertical direction of the drawing. The MMW 1013 extends parallel with and is laterally situated between the first grounded transmission line 1021b and 1021c of the coplanar stripline.

In operation, the CW optical signal from the laser 1005 is coupled to the MMW 1013 through the single mode optical waveguide 1010, mode converter 1011 and the second input port of the Y-combiner 1012 of the NI-TFLNM 1020. The data signal is applied to the input port of the LNA 1030 for amplification. The bias tee 1025 receives amplified data signal from the output port of LNA 1030 through its first input port. Further the bias tee receives a fixed DC voltage through its second input port. The bias tee 1025 combines the data signal and the DC voltage and sends them to the first end of the signal transmission line 1021a through its output port. Specifically, the DC voltage will tune the propagation constant of the two halves of the MMW 1013 (e.g., the half of MMW 1013 closer to the first grounded transmission line 1021b, and the other half of MMW 1013 closer to the second grounded transmission line 1021c), by doing this the optical power in MMW 1013 can be selectively fed to the two output ports of the Y-splitter 1014. With the designated optical power feeding, the NI-TFLNM 1020 can be set to work at quadrature point. The value of the DC voltage is determined by the structure size (e.g., the widths of MMW 1013 and signal transmission line 1022a, the length of the signal transmission line 1021a and the associated grounded transmission lines 1021b and 1021c) of the NI-TFLNM 1020. Data signal will modulate the propagation constant of the two halves of the MMW 1013, by doing this the optical power in MMW 1013 can be modulated to the two output ports of the Y-splitter 1014, and so the data can be encoded to the optical power that travels in either of the two output ports of the Y-splitter 1014. The data encoding should be done when the NI-TFLNM 1020 is stabilized at quadrature point, which, as prescribed, can be achieved by the fixed DC voltage. The modulated optical signal exits the NI-TFLNM 1020 and transfers to receiver through the output optical waveguide 1016 (or output optical fiber 1016).

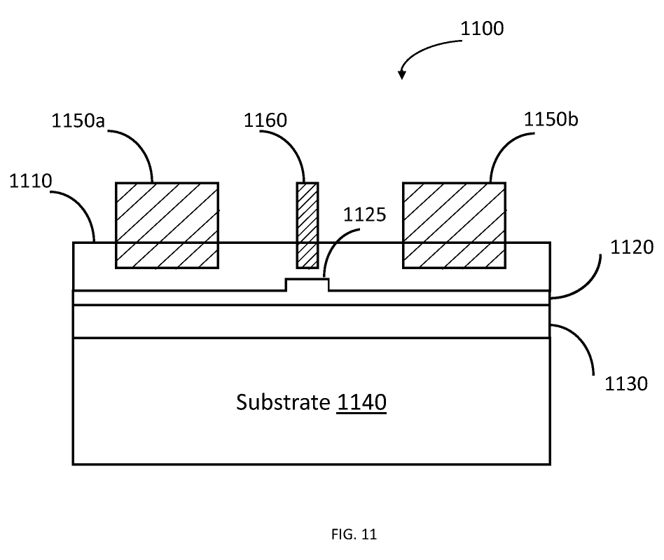

FIG. 11 illustrates a cross-sectional view of an example Non-interferometric Thin Film Lithium Niobate Modulator (NI-TFLNM) 920 (or 1020) of FIGS. 9 and 10 along an axis transverse of the optical signal propagation in the modulation region (e.g., the region proximate the first and second optical signal branches) in accordance with another aspect of the disclosure, as shown, the NI-TFLNM 920 (or 1020) may be formed on a substrate 1140 (e.g., quartz, fused silica SiO₂, or silicon (Si) substrate). The NI-TFLNM 920 (or 1020) further includes a bonding layer 1130 (e.g., fused silica SiO₂, Silicon Oxynitride SiNₓO_{y}, epoxy, or glue) disposed over and/or on the substrate 1140.

The NI-TFLNM 920 (or 1020) includes a lithium niobate (LN) slab 1120 including ridge waveguides 1125 formed on top surface of the LN slab 1120. The LN slab 1120 is disposed over and/or on the bonding layer 1130. That is, the bonding layer 1130 serves to bond the LN slab 1120 to the substrate 1140. The ridge waveguides may be formed by Ar⁺-based reactive ion etching of the LN slab 1120. The NI-TFLNM 920 (or 1020) further includes a buffer layer 1110 (e.g., fused silica SiO₂, Silicon Oxynitride SiNₓO_{y}, epoxy, or glue) disposed over and/or on the LN slab 1120 and ridge waveguides 1125.

The thickness of the substrate 1140 may be around 0.5 mm or around 1 mm. The thickness of the bonding laser 1130 may be between 0.5 μm and 10 μm. The thickness of the LN slab 1120 may be between 100 nm and 500 nm. The thickness of the ridge waveguides 1125 may be between 100 nm and 500 nm. The width of the ridge waveguides 1125 may be between 400 nm and 4μm. The thickness of the buffer layer 1110 may be between 100 nm and 5 μm.

The NI-TFLNM 920 (or 1020) further includes signal transmission line 1160 of the coplanar stripline disposed over and/or on top of the ridge waveguide 1125 but may not attach to the ridge waveguide 1125. The associated first and second grounded transmission line 1150a and 1150b of the coplanar stripline disposed over and/or on the LN slab 1120 but may not attach to the LN slab 1120. The coplanar stripline may be formed of any suitable electrical conductor, such as gold (Au) and may be embedded in the buffer layer 1110.

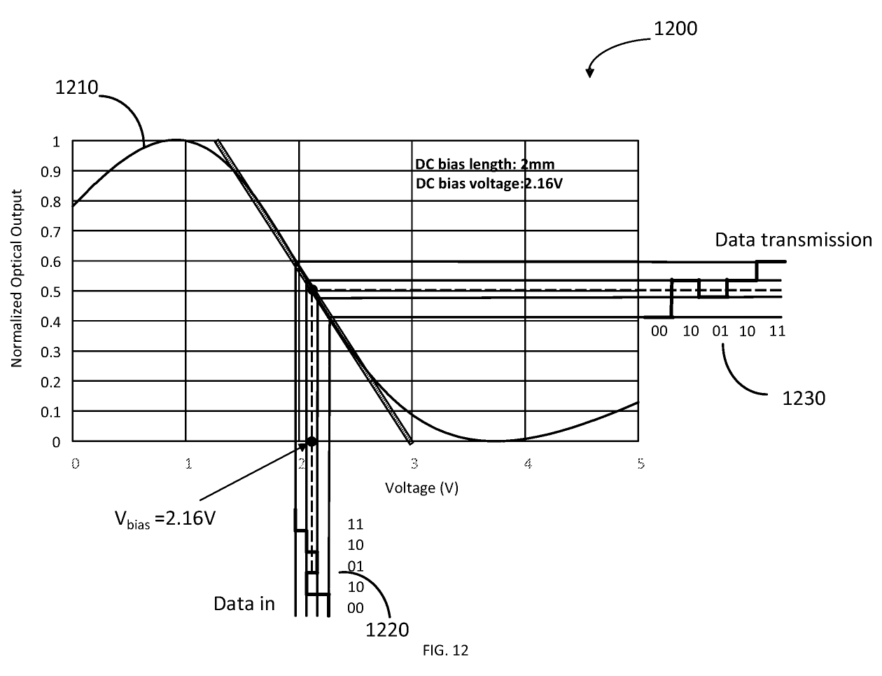

FIG. 12 illustrates a graph of transfer function of Non-Interferometric Thin Film Lithium Niobate Modulators (NI-TFLNM) 420 and 520 for data transmission of FIGS. 4 and 5 in accordance with another aspect of the disclosure. The horizontal axis represents Voltage in unit Volts from 0 Volts to 5 Volts. The vertical axis represents normalized optical output of the NI-TFLNM 420 or 520. The wave 1210 is a transmission function of the NI-TFLNM 420 or 520 when the DC bias conductor 422a and the associated grounded conductor 422b (and 422c) of NI-TFLNM 420 is 2mm long or the signal transmission line 521a and the associated grounded transmission line 521b (and 521c) of NI-TFLN 520 is 2mm long. The bias voltage for NI-TFLNM 420 or 520 to work at substantially quadrature point may be 2.16V.

An example 4-level Pulse Amplitude Modulation input digital signal (PAM4) “0010011011” is fed to NI-TFLNM 420 or 520 to modulate the optical power at quadrature point, the output optical signal 1230 will carry the information of the input PAM4 digital signal 1220. Specifically, the input PAM4 digital signal 1220 has the five 2 bits data “0010011011” with each 2 bits corresponding to a voltage level in electrical domain. The output optical signal 1230 will represent the PAM4 digital signal 1220 in optical domain with the help of four optical power levels.

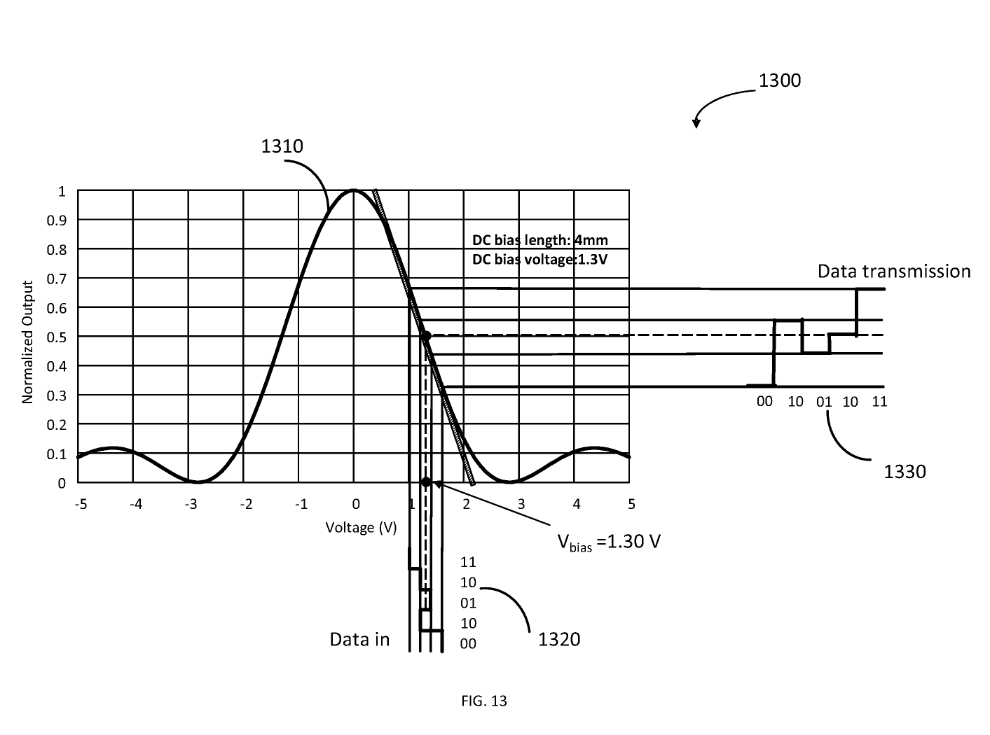

FIG. 13 illustrates a graph of transfer function of Non-Interferometric Thin Film Lithium Niobate Modulators (NI-TFLNM) 620 and 720 for data transmission of FIGS. 6 and 7 in accordance with another aspect of the disclosure. The horizontal axis represents Voltage in unit Volts from -5 Volts to 5 Volts. The vertical axis represents normalized optical output of the NI-TFLN 620 or 720. The wave 1310 is a transmission function of the NI-TFLNM 620 or 720 when the DC bias conductor 622a and the associated grounded conductor 622b (and 622c) of NI-TFLNM 620 is 4mm long or the signal transmission line 721a and the associated grounded transmission line 721b (and 721c) of NI-TFLNM 720 is 4mm long. The bias voltage for NI-TFLNM 620 or 720 to work at substantially quadrature point may be 1.30V.

An example 4-level Pulse Amplitude Modulation input digital signal (PAM4) “0010011011” is fed to NI-TFLNM 620 or 720 to modulate the optical power at quadrature point, the output optical signal 1330 will carry the information of the input PAM4 digital signal 1320. Specifically, the input PAM4 digital signal 1320 has the five 2 bits data “0010011011” with each 2 bits corresponding to a voltage level in electrical domain. The output optical signal 1330 will represent the PAM4 digital signal 1320 in optical domain with the help of four optical power levels.

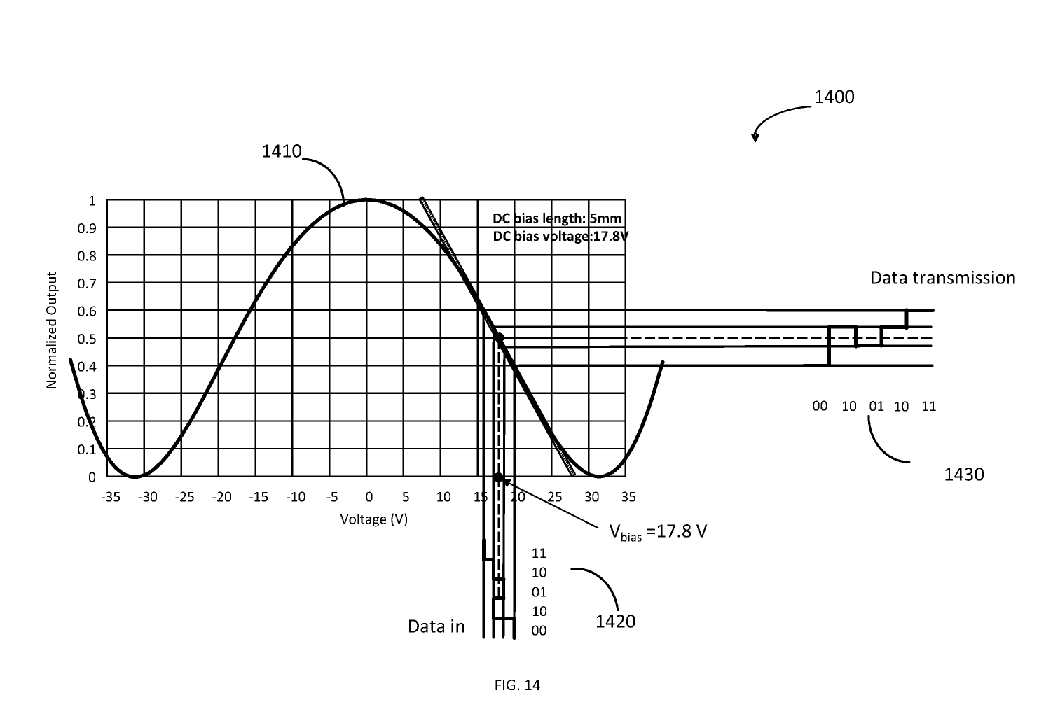

FIG. 14 illustrates a graph of transfer function of Non-Interferometric Thin Film Lithium Niobate Modulators (NI-TFLNM) 920 and 1020 for data transmission of FIGS. 9 and 10 in accordance with another aspect of the disclosure. The horizontal axis represents Voltage in unit Volts from -35 Volts to 35 Volts. The vertical axis represents normalized optical output of the NI-TFLNM 920 or 1020. The trace 1410 is a transmission function of the NI-TFLNM 920 or 1020 when the DC bias conductor 922a and the associated grounded conductor 922b (and 922c) of NI-TFLNM 920 is 5mm long or the signal transmission line 1021a and the associated grounded transmission line 1021b (and 1021c) of NI-TFLNM 1020 is 5mm long. The bias voltage for NI-TFLNM 1020 or 1020 to work at substantially quadrature point may be 17.8V.

An example 4-level Pulse Amplitude Modulation input digital signal (PAM4) “0010011011” is fed to NI-TFLNM 920 or 1020 to modulate the optical power at quadrature point, the output optical signal 1430 will carry the information of the input PAM4 digital signal 1420. Specifically, the input PAM4 digital signal 1420 has the five 2 bits data “0010011011” with each 2 bits corresponding to a voltage level in electrical domain. The output optical signal 1430 will represent the PAM4 digital signal 1420 in optical domain with the help of four optical power levels.

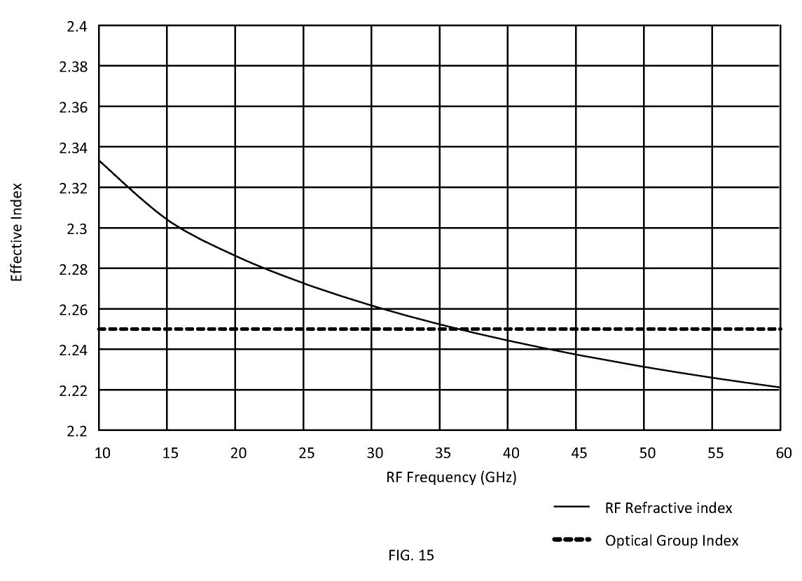

FIG. 15 illustrates a graph of an example matching between the RF refractive index and the optical group refractive index of Non-Interferometric Thin Film Lithium Niobate Modulators (NI-TFLNM) 420 and 520 for data transmission of FIGS. 4 and 5 in accordance with another aspect of the disclosure. The horizontal axis represents frequency in unit of GHz from 10 GHz to 60 GHz. The vertical axis represents an effective refractive index from 2.2 to 2.4 for both RF wave and optical wave. The wave velocity is related to the speed of the wave in vacuum divided by the effective refractive index.

The horizontal dashed line at slightly higher than 2.24 represents the optical group velocity via the first and second optical waveguide branches 413a and 413b of FIG. 4 and the first and second optical waveguide branches 513a and 513b of FIG. 5. With regard to RF signal velocity via the coplanar transmission line 421a, 421b and 421c of FIG. 4 and the coplanar transmission line 521a, 521b and 521c of FIG. 5, the graph depicts the RF refractive index decreases from a value between 2.32 and 2.34 at 10 GHz to a value of 2.22 at 60 GHz.

As the graph shows, the velocity matching between RF wave and optical wave can be achieved at a large frequency range.

The structure size for achieving the velocity matching includes: The thickness of the substrate 840 may be 0.5 mm. The thickness of the bonding layer 830 may be 3 μm. The thickness of the LN slab 820 may be 300 nm. The thickness of the ridge waveguides 825a and 825b may be 300 nm. The width of the ridge waveguides 825a and 825b may be 1 μm. The thickness of the buffer layer 810 may be 700 nm. The thickness of the signal transmission line 860 and the associated grounded transmission lines 850a and 850b may be 1.2 μm.

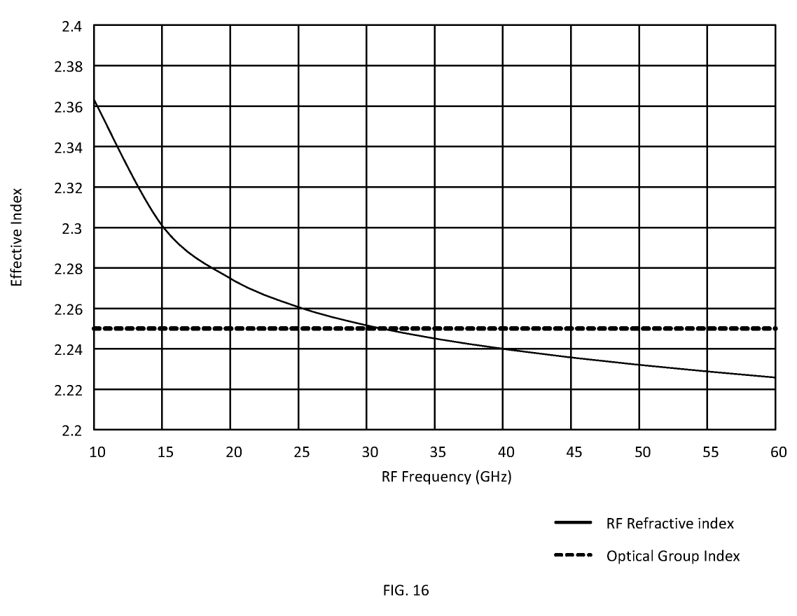

FIG. 16 illustrates a graph of an example matching between the RF refractive index and the optical group refractive index of Non-Interferometric Thin Film Lithium Niobate Modulators (NI-TFLNM) 620 and 720 for data transmission of FIGS. 6 and 7 in accordance with another aspect of the disclosure. The horizontal axis represents frequency in unit of GHz from 10 GHz to 60 GHz. The vertical axis represents an effective refractive index from 2.2 to 2.4 for both RF wave and optical wave. The wave velocity is related to the speed of the wave in vacuum divided by the effective refractive index.

The horizontal dashed line at slightly higher than 2.24 represents the optical group velocity via the first and second optical waveguide branches 613a and 613b of FIG. 6 and the first and second optical waveguide branches 713a and 713b of FIG. 7. With regard to RF signal velocity via the coplanar transmission line 621a, 621b and 621c of FIG. 6 and the coplanar transmission line 721a, 721b and 721c of FIG. 7, the graph depicts the RF refractive index decreases from a value around 2.36 at 10 GHz to a value slightly higher than 2.22 at 60 GHz.

As the graph shows, the velocity matching between RF wave and optical wave can be achieved at a large frequency range.

The structure size for achieving the velocity matching includes: The thickness of the substrate 840 may be 0.5 mm. The thickness of the bonding layer 830 may be 3 μm. The thickness of the LN slab 820 may be 300 nm. The thickness of the ridge waveguides 825a and 825b may be 300 nm. The width of the ridge waveguides 825a and 825b may be 1 μm. The thickness of the buffer layer 810 is 500 nm. The thickness of the signal transmission line 860 and the associated grounded transmission lines 850a and 850b may be 1.2 μm.

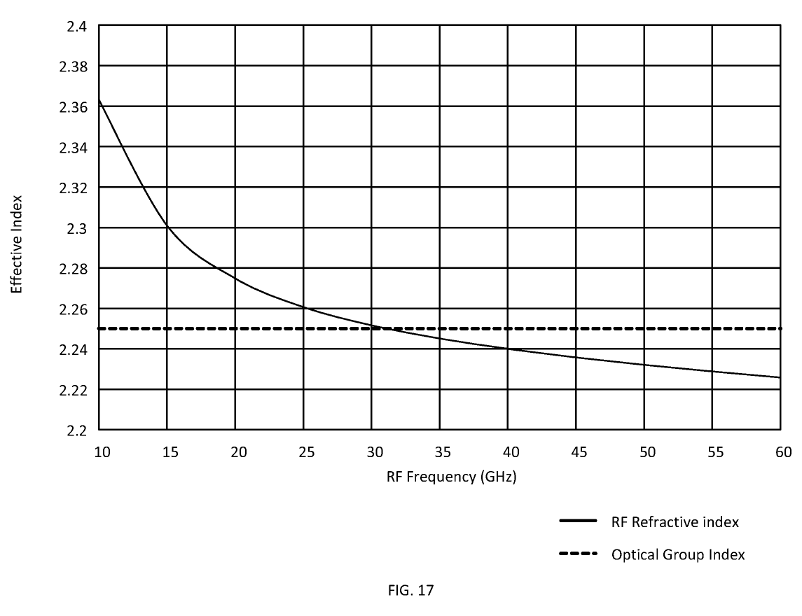

FIG. 17 illustrates a graph of an example matching between the RF refractive index and the optical group refractive index of Non-Interferometric Thin Film Lithium Niobate Modulators (NI-TFLNM) 920 and 1020 for data transmission of FIGS. 9 and 10 in accordance with another aspect of the disclosure. The horizontal axis represents frequency in unit of GHz from 10 GHz to 60 GHz. The vertical axis represents an effective refractive index from 2.1 to 2.7 for both RF wave and optical wave. The wave velocity is related to the speed of the wave in vacuum divided by the effective refractive index.

The horizontal dashed line at slightly higher than 2.2 represents the optical group velocity via MMW 913 of FIG. 9 and the MMW 1013 of FIG. 10. With regard to RF signal velocity via the coplanar transmission line 921a, 921b and 921c of FIG. 9 and the coplanar transmission line 1021a, 1021b and 1021c of FIG. 10, the graph depicts the RF refractive index decreases from a value around 2.7 at 10 GHz to a value between 2.1 and 2.2 at 60 GHz.

As the graph shows, the velocity matching between RF wave and optical wave can be achieved at a large frequency range.

The structure size for achieving the velocity matching includes: The thickness of the substrate 1140 may be 0.5 mm. The thickness of the bonding layer 1130 may be 3 μm. The thickness of the LN slab 1120 may be 300 nm. The thickness of the ridge waveguide 1125 may be 300 nm. The width of the ridge waveguide 1125 may be 2 μm. The thickness of the buffer layer 1110 may be 1.4 μm. The thickness of the signal transmission line 1160 and the associated grounded transmission lines 1150a and 1150b may be 800 nm.

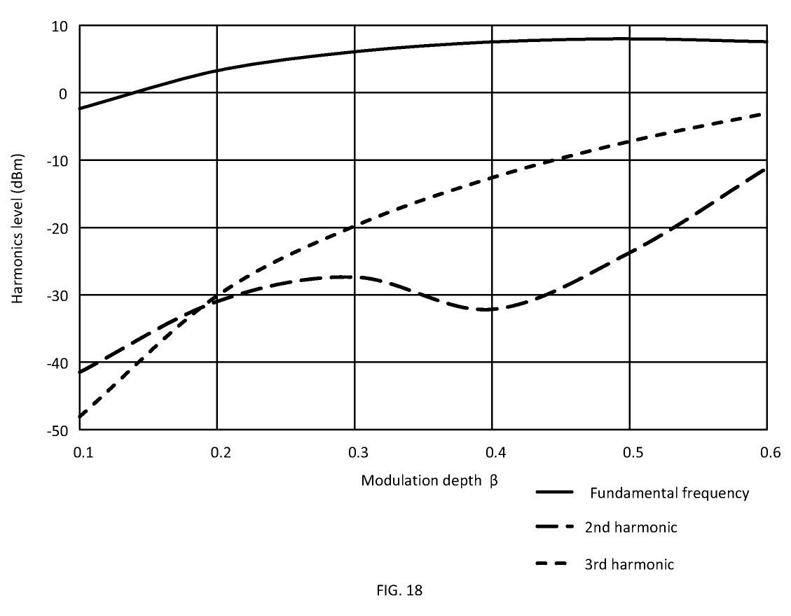

FIG. 18 illustrates a graph of an example amplitude of the fundamental frequency, second, and third harmonics that can be generated in the optical power when a sinusoidal input data signal with different modulation depth is applied to the transfer function 1210 of FIG. 12 in accordance with another aspect of the disclosure. The horizontal axis represents the modulation depth β from 0.1 to 0.6. The vertical axis represents the amplitude in unit of dBm from -50dBm to 10dBm for fundamental frequency, second, and third harmonics.

The definition of modulation depth β is the ratio between the peak-peak voltage of the input data signal and the V_{π} of the transmission function 1210. The V_{π} of the transmission function 1210 is defined as the voltage difference that induces the “1” and “0” of the optical output.

In the graph, the solid line characteristic for the generated fundamental frequency versus modulation depth, the larger dashed line characteristic for the generated second harmonic versus modulation depth, and the smaller dashed line characteristic for the generated third harmonic versus modulation depth.

The fact that the second and third harmonics are much smaller than the fundamental frequency verified the excellent linearity of the NI-TFLNM 420 and 520 for data transmission 400 and 500.

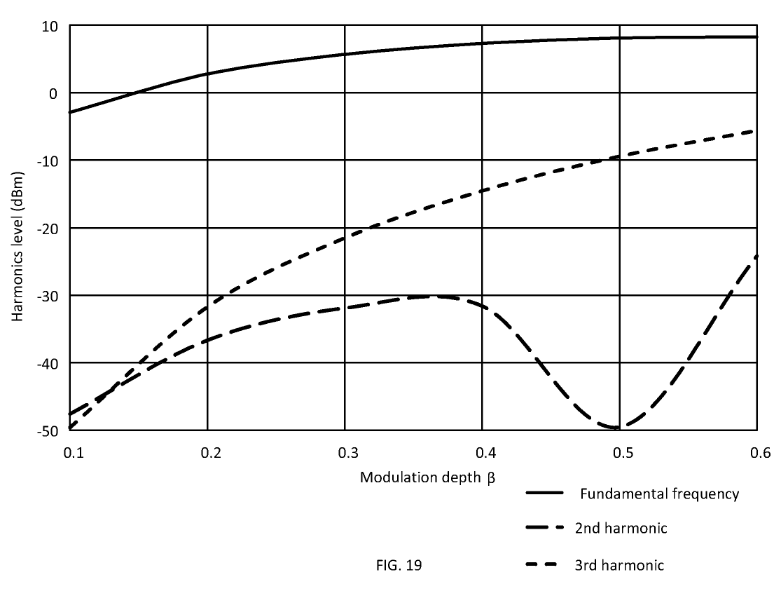

FIG. 19 illustrates a graph of an example amplitude of the fundamental frequency, second, and third harmonics that can be generated in the optical power when a sinusoidal input data signal with different modulation depth is applied to the transfer function 1310 of FIG. 13 in accordance with another aspect of the disclosure. The horizontal axis represents the modulation depth β from 0.1 to 0.6. The vertical axis represents the amplitude in unit of dBm from -50dBm to 10dBm for fundamental frequency, second, and third harmonics.

The definition of modulation depth β is the ratio between the peak-peak voltage of the input data signal and the V_{π} of the transmission function 1310. The V_{π} of the transmission function 1310 is defined as the voltage difference that induces the “1” and “0” of the optical output.

In the graph, the solid line characteristic for the generated fundamental frequency versus modulation depth, the larger dashed line characteristic for the generated second harmonic versus modulation depth, and the smaller dashed line characteristic for the generated third harmonic versus modulation depth.

The fact that the second and third harmonics are much smaller than the fundamental frequency verified the excellent linearity of the NI-TFLNM 620 and 720 for data transmission 600 and 700.

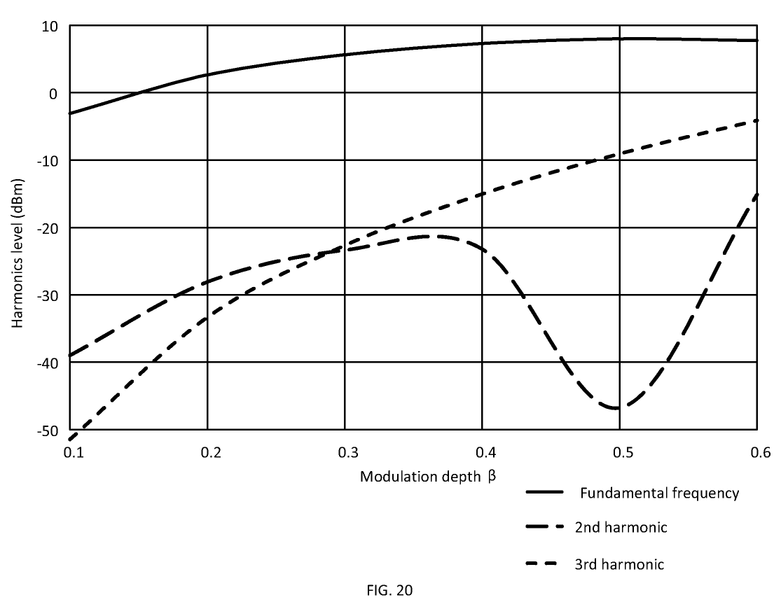

FIG. 20 illustrates a graph of an example amplitude of the fundamental frequency, second, and third harmonics that can be generated in the optical power when a sinusoidal input data signal with different modulation depth is applied to the transfer function 1410 of FIG. 14 in accordance with another aspect of the disclosure. The horizontal axis represents the modulation depth β from 0.1 to 0.6. The vertical axis represents the amplitude in unit of dBm from -50dBm to 10dBm for fundamental frequency, second, and third harmonics.

The definition of modulation depth β is the ratio between the peak-peak voltage of the input data signal and the V_{π} of the transmission function 1410. The V_{π} of the transmission function 1410 is defined as the voltage difference that induces the “1” and “0” of the optical output.

In the graph, the solid line characteristic for the generated fundamental frequency versus modulation depth, the larger dashed line characteristic for the generated second harmonic versus modulation depth, and the smaller dashed line characteristic for the generated third harmonic versus modulation depth.

The fact that the second and third harmonics are much smaller than the fundamental frequency verified the excellent linearity of the NI-TFLNM 920 and 1020 for data transmission 900 and 1000.

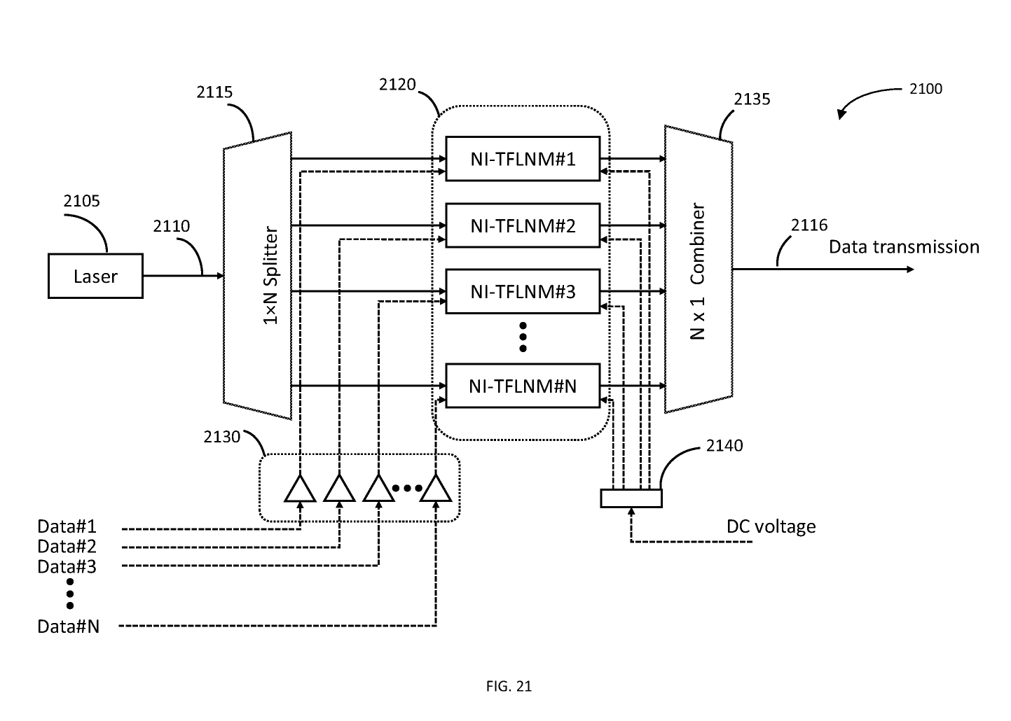

FIG. 21 illustrates a block diagram of an example Non-Interferometric Thin Film Lithium Niobate Modulator array (NI-TFLNM array, it has N pcs of NI-TFLNM integrated or fabricated in parallel in a single device) 2120 for multi-channel (here for example: N-channel, N is an integer larger than 1) data transmission 2100 in accordance with another aspect of the disclosure. As described previously, the individual NI-TFLNM of the NI-TFLNM Array 2120 may have the configuration of NI-TFLNM 420, or 520, or 620, or 720, or 920, or 1020.

In the optical domain, the multi-channel data transmission diagram 2100 includes a CW laser 2105, a single mode optical waveguide 2110, a 1×N optical power splitter 2115, a NI-TFLNM array 2120, an N×1 optical power combiner 2135 and an output optical waveguide 2116 (or output optical fiber 2116).

The CW optical power from the laser 2105 is coupled to the 1×N optical power splitter 2115 through the single mode optical waveguide 2110 and the input port of the 1×N optical power splitter 2115. The 1×N optical power splitter 2115 equally distributes the optical power into N parts and couples each part into each NI-TFLNM of the NI-TFLNM array 2120 through the N output ports of the 1×N optical power splitter 2115 and the N input ports of NI-TFLNM array.

In the electrical domain, the multi-channel data transmission diagram 2100 includes a NI-TFLNM array 2120, a low noise RF amplifier array (LNA array) 2130, and a 1×N DC voltage adaptor 2140.

The LNA array 2130 includes N pcs of LNA with each input configured to receive an electrical data signal. The LNA array 2130 also includes each output coupled to one NI-TFLNM of the NI-TFLNM array 2120.

The 1×N DC voltage adaptor 2140 has one input port and N output ports. The 1×N DC voltage adaptor 2140 has its input port configured to receive a fixed DC voltage and then apply the DC voltage to each NI-TFLNM of the NI-TFLNM array 2120 through its N output ports.

In operation, the CW optical signal from the laser 2105 is coupled to each NI-TFLNM of the NI-TFLNM array 2120 through the single mode optical waveguide 2110 and the 1×N optical power splitter 2115. A fixed DC voltage is applied to each NI-TFLNM of the NI-TFLNM array 2120 through the DC voltage adaptor 2140 to make each NI-TFLNM of the NI-TFLNM array 2120 working at quadrature point by tuning the propagation constant of each NI-TFLNM of the NI-TFLNM array 2120. Data signal is amplified by each LNA of the LNA array 2130 and then applied to each NI-TFLNM of the NI-TFLNM array 2120 for data encoding to the optical power by modulating the propagation constant of each NI-TFLNM of the NI-TFLNM array 2120. The modulated optical power from the NI-TFLNM array 2120 that carries the data signal is combined and transferred to remote receiver through the N×1 optical power combiner 2135 and an output optical waveguide 2116 (or output optical fiber 2116).

The previous description of the disclosure is provided to enable any person skilled in the art to make or use the disclosure. Various modifications of the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus, comprising:
an electro-optical modulator, comprising:
an optical splitter including:
an input port configured to receive a continuous wave (CW) laser power;
a first output port; and
a second output port;
a first optical waveguide including a first input port coupled to the first output port of the optical splitter and a first output port;
a second optical waveguide including a second input port coupled to the second output port of the optical splitter and a terminated port;
a signal transmission line extending substantially parallel with and situated laterally between the first and second optical waveguides;
a first grounded transmission line extending substantially parallel with the first optical waveguide, wherein the first optical waveguide is situated laterally between the signal transmission line and the first grounded transmission line; and
a second grounded transmission line extending substantially parallel with the second optical waveguide, wherein the second optical waveguide is situated laterally between the signal transmission line and the second grounded transmission line.

2. The apparatus of claim 1, wherein the signal transmission line is configured to receive a radio frequency (RF) signal for modulating the CW laser power to generate a modulated optical signal at the first output port of the first optical waveguide.

3. The apparatus of claim 2, wherein the signal transmission line is configured to receive a direct current (DC) bias voltage.

4. The apparatus of claim 3, wherein the DC bias voltage is configured to set a propagation constant of the first and second optical waveguides.

5. The apparatus of claim 1, further comprising:
a DC bias electrical conductor configured to receive a DC bias voltage, wherein the DC bias electrical conductor extends substantially parallel with and situated laterally between the first and second optical waveguides;
a first grounded electrical conductor extending parallel with the first optical waveguide, wherein the first optical waveguide is situated laterally between the DC bias electrical conductor and the first grounded electrical conductor; and
a second grounded electrical conductor extending parallel with the second optical waveguide, wherein the second optical waveguide is situated laterally between the DC bias electrical conductor and the second grounded electrical conductor.

6. The apparatus of claim 5, wherein the DC bias voltage is configured to set a propagation constant of the first and second optical waveguides.

7. The apparatus of claim 1, further comprising:
a laser configured to generate the CW laser power;
a 1xN splitter configured to split the CW laser power into a set of N CW laser power;
a set of N amplifiers configured to generate a set of N channel data signals, respectively;
a set of N electro-optical modulators including the electro-optical modulator configured to modulate the set of N CW laser power with the set of N channel data signals to generate a set of N modulated optical signals, respectively, wherein each electro-optical modulator of the set is defined per claim 1;
a 1xN voltage adapter configured to provide a set of direct current (DC) bias voltages to the set of N electro-optical modulators based on an input DC bias voltage, respectively; and
a Nx1 combiner configured to combine the set of N modulated optical signals to generate an output modulated optical signal.

8. An apparatus, comprising:
an electro-optical modulator, comprising:
a first optical waveguide including an input port configured to receive a continuous wave (CW) laser and a first terminated port;
a second optical waveguide including a second terminated port and an output port;
a signal transmission line extending substantially parallel with and situated laterally between the first and second optical waveguides;
a first grounded transmission line extending substantially parallel with the first optical waveguide, wherein the first optical waveguide is situated laterally between the signal transmission line and the first grounded transmission line; and
a second grounded transmission line extending substantially parallel with the second optical waveguide, wherein the second optical waveguide is situated laterally between the signal transmission line and the second grounded transmission line.

9. The apparatus of claim 8, wherein the signal transmission line is configured to receive a radio frequency (RF) signal for modulating the CW laser to generate a modulated optical signal at the output port of the second optical waveguide.

10. The apparatus of claim 9, wherein the signal transmission line is configured to receive a direct current (DC) bias voltage.

11. The apparatus of claim 10, wherein the DC bias voltage is configured to set a propagation constant of the first and second optical waveguides.

12. The apparatus of claim 8, further comprising:
a DC bias electrical conductor configured to receive a DC bias voltage, wherein the DC bias electrical conductor extends substantially parallel with and situated laterally between the first and second optical waveguides;
a first grounded electrical conductor extending parallel with the first optical waveguide, wherein the first optical waveguide is situated laterally between the DC bias electrical conductor and the first grounded electrical conductor; and
a second grounded electrical conductor extending parallel with the second optical waveguide, wherein the second optical waveguide is situated laterally between the DC bias electrical conductor and the second grounded electrical conductor.

13. The apparatus of claim 12, wherein the DC bias voltage is configured to set a propagation constant of the first and second optical waveguides.

14. The apparatus of claim 8, further comprising:
a laser configured to generate the CW laser power;
a 1xN splitter configured to split the CW optical power into a set of N CW laser power;
a set of N amplifiers configured to generate a set of N channel data signals, respectively;
a set of N electro-optical modulators including the electro-optical modulator configured to modulate the set of N CW laser power with the set of N channel data signals to generate a set of N modulated optical signals, respectively, wherein each electro-optical modulator of the set is defined per claim 8;
a 1xN voltage adapter configured to provide a set of direct current (DC) bias voltages to the set of N electro-optical modulators based on an input DC bias voltage, respectively; and
a Nx1 combiner configured to combine the set of N modulated optical signals to generate an output modulated optical signal.

15. An apparatus, comprising:
an electro-optical modulator, comprising:
a Y-combiner including a first input port configured to receive a continuous wave (CW) laser, a first terminated port, and a first output port;
a Y-splitter including a second input port, a second output port, and a second terminated port;
an optical waveguide including an input port coupled to the first output port of the Y-combiner, and an output port coupled to the second input port of the Y-splitter;
a signal transmission line extending substantially parallel with and overlying the optical waveguide; and
first and second grounded transmission lines extending substantially parallel with and situated laterally on both sides of the signal transmission, respectively.

16. The apparatus of claim 15, wherein the signal transmission line is configured to receive a radio frequency (RF) signal for modulating the CW laser power to generate a modulated optical signal at the second output port of the Y-splitter.

17. The apparatus of claim 16, wherein the signal transmission line is configured to receive a direct current (DC) bias voltage.

18. The apparatus of claim 17, wherein the optical waveguide includes a first half closer to the first grounded transmission line, and a second half closer to the second grounded transmission line, and wherein the DC bias voltage is configured to set propagation constants of the first and second halves of the optical waveguide, respectively.

19. The apparatus of claim 15, further comprising:
a DC bias electrical conductor configured to receive a DC bias voltage, wherein the DC bias electrical conductor extends substantially parallel with and overlying the optical waveguide; and
first and second grounded electrical conductors extending substantially parallel with and situated laterally on both sides of the DC bias electrical conductor, respectively.

20. The apparatus of claim 19, wherein the optical waveguide includes a first half closer to the first grounded transmission line, and a second half closer to the second grounded transmission line, and wherein the DC bias voltage is configured to set propagation constants of the first and second halves of the optical waveguide, respectively.

21. The apparatus of claim 15, further comprising:
a laser configured to generate the CW laser power;
a 1xN splitter configured to split the CW laser into a set of N CW laser power;
a set of N amplifiers configured to generate a set of N channel data signals, respectively;
a set of N electro-optical modulators including the electro-optical modulator configured to modulate the set of N CW laser power with the set of N channel data signals to generate a set of N modulated optical signals, respectively, wherein each electro-optical modulator of the set is defined per claim 15;
a 1xN voltage adapter configured to provide a set of direct current (DC) bias voltages to the set of N electro-optical modulators based on an input DC bias voltage, respectively; and
a Nx1 combiner configured to combine the set of N modulated optical signals to generate an output modulated optical signal.
